(19) United States
(12) Patent Application Publication
(10) Pub. No.: US 2005/0050210 A1
(43) Pub. Date: Mar. 3, 2005

(54) Issue tracking systems and methods

(76) Inventor: Douglas Mark Kennedy, Thornton, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/650,394

(22) Filed: Aug. 28, 2003

(51) Int. Cl. G06F 15/16; H04L 9/32

(52) U.S. Cl. 709/229; 713/200

(57) ABSTRACT

An issue tracking system and method are disclosed. An embodiment comprises providing a log-in page to log-in a user, receiving user information from the user in the log-in page, providing one of a plurality of interface pages to process an issue, said interface page has a configuration corresponding to a predetermined access level of the user, providing an issue record, and providing an embedded uniform resource locator of the issue record.

### BACKGROUND

Issue tracking systems are used by organizations to enable the recording, control, and/or reporting of issues. Issues include defects, and identified improvements or improvement opportunities, in products and/or processes. Issue tracking systems also provide a mechanism to facilitate remedial measures addressing the issue. For example, once an opportunity for a product improvement has been identified and recorded in the issue tracking system, responsible parties can use the recorded information to determine and implement an array of solutions to achieve the product improvement, as well as to track the progress in development.

A problem with many issue tracking systems is that users invest considerable time in using them, rendering such systems user-unfriendly. For example, navigation through a plurality of screens or pages (e.g., in web-based systems) are often time-consuming and counter-intuitive, with the user wasting time trying to determine such things as which person should receive notice of the issue, how to best identify or classify an issue, etc. In addition, users often spend considerable time implementing the individual tasks associated with these decisions.

Thus, a need exists in the industry to address the aforementioned and/or other deficiencies and/or inadequacies.

### SUMMARY

Embodiments of an issue tracking system are provided. One exemplar embodiment, among others, is a tracking method that comprises the following steps: providing a log-in page to log-in a user, receiving user information from the user in the log-in page, providing one of a plurality of interface pages to process an issue, said interface page has a configuration corresponding to a predetermined access level of the user, providing an issue record, and providing an embedded uniform resource locator of the issue record.

Another embodiment is a tracking system that comprises a processor configured to provide a log-in page to log-in a user, said processor configured to receive user information from the user in the log-in page, said processor configured to provide one of a plurality of interface pages to process an issue, said interface page has a configuration corresponding to a predetermined access level of the user, said processor configured to process an issue, said processor configured to provide an issue record, said processor configured to provide an embedded uniform resource locator of the issue record.

Another embodiment is a tracking system that comprises means for providing a log-in page to log-in a user, means for receiving user information from the user in the log-in page, means for providing one of a plurality of interface pages to process an issue, said interface page has a configuration corresponding to a predetermined access level of the user, means for providing an issue record, and means for providing an embedded uniform resource locator of the issue record.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects can be better understood with reference to the following drawings. The components in the drawings are not necessarily to scale. Moreover, in the drawings, like reference numerals designate corresponding parts throughout the several views.

FIG. 1A is a block diagram of an exemplar implementation for the issue tracking system.

FIG. 1B is a block diagram of the issue tracking system embodied in an exemplar computer.

FIG. 2 is a screen diagram of an exemplar log-in screen of the issue tracking system of FIG. 1B.

FIG. 3A is a screen diagram of an exemplar home screen of the issue tracking system of FIG. 1B.

FIG. 3B is a screen diagram of an exemplar administration screen displayed in response to selecting an administration tab icon in the home screen shown in FIG. 3A.

FIG. 3C is a screen diagram of an exemplar add user screen displayed in response to selecting an add user icon in the administration screen shown in FIG. 3B.

FIG. 3D is a screen diagram of an exemplar system usage screen displayed in response to selecting a view system usage icon in the administration screen shown in FIG. 3B.

FIG. 4 is a screen diagram of an exemplar site usage screen displayed in response to selecting a site usage icon in the home screen shown in FIG. 3A.

FIG. 5 is a screen diagram of an exemplar view issues screen of the issue tracking system of FIG. 1B.

FIG. 6 is a screen diagram of an exemplar view issues screen of the issue tracking system of FIG. 1B.

FIG. 7 is a screen diagram of an exemplar view issues screen displayed in response to selecting a view defects icon in the home screen shown in FIG. 3A.

FIG. 8 is a screen diagram of an exemplar history pop-up window displayed in response to selecting a history icon in the view issues screen of FIG. 7.

FIG. 9 is a screen diagram of an exemplar submit screen displayed in response to selecting a submit tab icon in the view issues screen shown in FIG. 7.

FIG. 10 is a screen diagram of an exemplar view defect screen displayed in response to selecting a view issues icon in the submit screen shown in FIG. 9.

FIG. 11 is a screen diagram of an exemplar modify screen displayed in response to selecting a modify issue button icon in the view issues screen of FIG. 10.

FIG. 12 is a screen diagram of an exemplar project screen displayed in response to selecting a project tab icon in the modify screen of FIG. 11.

FIG. 13 is a screen diagram of an exemplar modify screen displayed in response to selecting the modify tab icon of FIG. 12.

FIG. 14 is a screen diagram of an exemplar report screen displayed in response to selecting a report tab icon in the modify screen of FIG. 13.

FIG. 15 is a screen diagram of an exemplar report screen displayed in response to selecting a different format in a format line of FIG. 14.

FIG. 16 is a screen diagram of an exemplar report screen displayed in response to selecting a different project from the report screen of FIG. 15.

FIG. 17 is a screen diagram of an exemplar report screen that enables an analysis of issues resolved by engineer.

FIG. 18 is a screen diagram of an exemplar report screen displayed in response to selecting a different project and format from the report screen of FIG. 17.

FIG. 19 is a screen diagram of an exemplar report screen that shows issues in all states for a specified project.

FIG. 20 is a screen diagram of an exemplar search results screen.

### DETAILED DESCRIPTION

The description that follows will describe embodiments of an issue tracking system. The issue tracking system includes a web-based system that, through a variety of task-oriented, user interface screens or pages (herein pages and screens will be used interchangeably) provides a hierarchy of access levels as well as navigation features to a variety of users within an organization. The user interface screens are configured to be intuitive to a user, thus reducing the complexities (and thus time investment) in processing and/or tracking issues within a project or projects. Further, the user interface screens include many automatic features, such as browser-link icons and automatic email notification (e.g., email notification with embedded uniform resource locator (URL) of defect report), thus providing “transparent” services to the user.

The issue tracking system thus includes secure access, built-in report generation, real-time parseable/searchable reports by field (e.g., search issues per project, list of all issues of particular type, etc.), book-marked reports (e.g., every screen or page is an URL), and memory of requests. The report-generation features of the issue tracking system provide project management features (e.g., statistics of defect rates) within one project or across several projects that assist management in decision making for products, processes, and/or business development, among others.

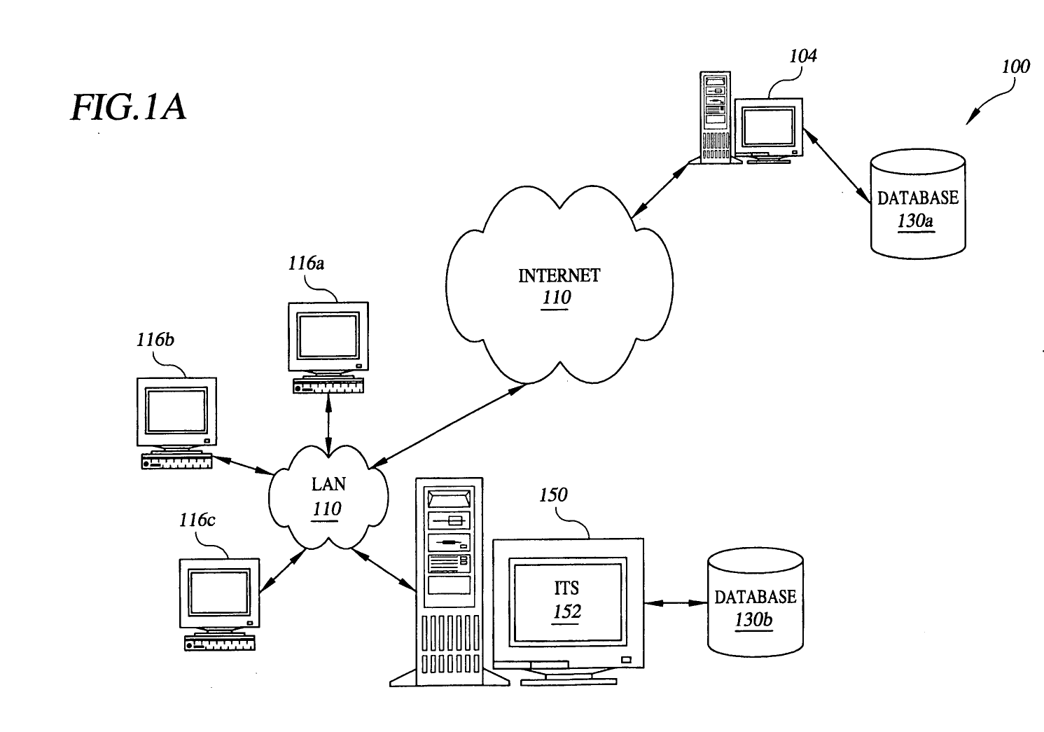

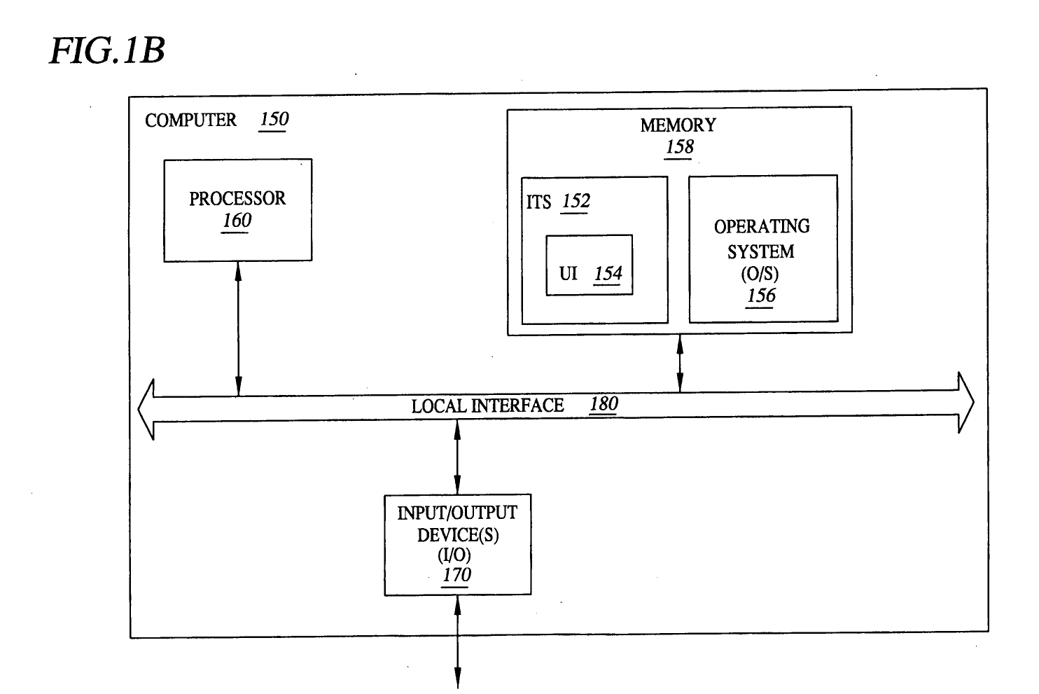

FIG. 1A is a block diagram depicting an exemplar network infrastructure 100 for implementing an embodiment of the issue tracking system (ITS) 152. The exemplar network infrastructure 100 includes one or more local area networks (LANs) 110 that support a plurality of workstations 116a-c, which are served by one or more LAN servers or computers 150 that include one or more accompanying databases 130b internal or external to the LAN server 150. The LAN server 150 is coupled to the Internet 110, with or without an intermediary Internet Service Provider (not shown), as is true for other components shown. As is well known to those skilled in the art, the Internet 110 comprises and is coupled to a host of other networks (e.g., LANs, wide area networks, regional area networks, etc.) and users. A central server 104 can be provided, which includes, or is in communication with, one or more associated central databases 130a, and is also coupled to the Internet 110, among other networks not shown.

In one embodiment, a central database 130a can be maintained and updated, and licensed out for use by one or more users or facilities, such as a corporate or institutional research facility. Access to the central database 130a can be implemented over the Internet 110, or in other embodiments, a local copy can be maintained at the LAN database 130b. In the latter embodiment, the LAN server 150 can support the workstations 116a-c, which, for example, access the LAN server 150 and database 130b via browser software at each workstation, according to well-known mechanisms.

Further, the mechanisms by which the workstations 116a-c access the LAN server 150 (or the LAN server 150 accesses the central server 104) include CGI (Common Gateway Interface), ASP (Application Service Provider), Java, among others.

One skilled in the art will also understand that the various databases, such as the database 130b, can be stored on a digital video disc (DVD) or other storage medium, run from the workstations 116a-c, network server 150, etc., and updated periodically or otherwise via the central server 104. Further, one skilled in the art would understand that communication among the various components in the exemplar network infrastructure 100 can be provided using one or more of a plurality of transmission mediums (e.g., Ethernet, T1, hybrid fiber/coax, etc.) and protocols (e.g., via HTTP and/or FTP, etc.).

FIG. 1B is a block diagram of the exemplar LAN server 150 that in one example embodiment can implement the ITS 152. With continued reference to FIG. 1A, one skilled in the art will understand that the exemplar LAN server 150 can be embodied as the workstations 116a-c and/or central server 104 of the exemplar network infrastructure 100, alone or in combination (i.e., in a single component, or distributed over several components in the exemplar network infrastructure 100), among other embodiments. Further, one skilled in the art will understand that additional components or different components with similar functionality can be included in the LAN server 150, and/or some components can be omitted, in other embodiments. The issue tracking system 152 is implemented in software, as an executable program, and is executed by a special or general purpose digital computer, such as a personal computer (PC; IBM-compatible, Apple-compatible, or otherwise), workstation, minicomputer, or mainframe computer. The issue tracking system 152 includes a user-interface (UI) module 154 that provides display functions according to well-known underlying display generation and formatting mechanisms.

If implemented in hardware, as in an alternative embodiment, the issue tracking system 152 can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Generally, in terms of hardware architecture, as shown in FIG. 1B, the LAN server 150 includes a processor 160, memory 158, and one or more input and/or output (1/0) devices 170 (or peripherals) that are communicatively coupled via a local interface 180. The local interface 180 can be, for example but not limited to, one or more buses or other wired or wireless connections, as is known in the art. The local interface 180 may have additional elements, which are omitted for simplicity, such as controllers, buffers (caches), drivers, repeaters, and receivers, to enable communications. Further, the local interface 180 may include address, control, and/or data connections to enable appropriate communications among the aforementioned components.

The processor 160 is a hardware device capable of executing software, particularly that stored in memory 158. The processor 160 can be any custom made or commercially available processor, a central processing unit (CPU), an auxiliary processor among several processors associated with the LAN server 150, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc, or a 68xxx series microprocessor from Motorola Corporation.

Memory 158 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 158 may incorporate electronic, magnetic, optical, and/or other types of storage media. Note that memory 158 can have a distributed architecture, where various components are situated remote from one another, but can be accessed by the processor 160.

The software in memory 158 may include one or more separate programs, each of which comprises an ordered listing of executable instructions for implementing logical functions. In the example of FIG. 1B, the software in the memory 158 includes the issue tracking system 152 and a suitable operating system (O/S) 156. A nonexhaustive list of examples of suitable commercially available operating systems 156 is as follows: (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., PalmOS available from Palm Computing, Inc., and Windows CE available from Microsoft Corporation). The operating system 156 essentially controls the execution of other computer programs, such as the issue tracking system 152, and provides scheduling, input-output control, file and data management, memory management, and communication control and related services.

The issue tracking system 152 can be a source program, executable program (object code), script, and/or any other entity comprising a set of instructions to be performed. When a source program, then the program needs to be translated via a compiler, assembler, interpreter, or the like, which may or may not be included within memory 158, so as to operate properly in connection with the operating system 156. Furthermore, the issue tracking system 152 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, ASP, and Ada.

The I/O devices 170 may include input devices, for example but not limited to, a keyboard, mouse, scanner, microphone, etc. Furthermore, the I/O devices 170 may also include output devices, for example but not limited to, a printer, display, etc. Finally, the I/O devices 170 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the LAN server 150 is a PC, workstation, or the like, the software in memory 158 may further include a basic input output system (BIOS) (omitted for brevity). The BIOS is a set of essential software routines that initialize and test hardware at startup, start the operating system 156, and support the transfer of data among the hardware devices. The BIOS is stored in ROM so that the BIOS can be executed when the LAN server 150 is activated.

When the LAN server 150 is in operation, the processor 160 is configured to execute software stored within memory 158, to communicate data to and from memory 158, and to generally control operations of the LAN server 150 pursuant to the software. The issue tracking system 152 and the operating system 156, in whole or in part, but typically the latter, are read by the processor 160, perhaps buffered within the processor 160, and then executed.

When the issue tracking system 152 is implemented in software, as is shown in FIG. 1B, the issue tracking system 152 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The issue tracking system 152 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

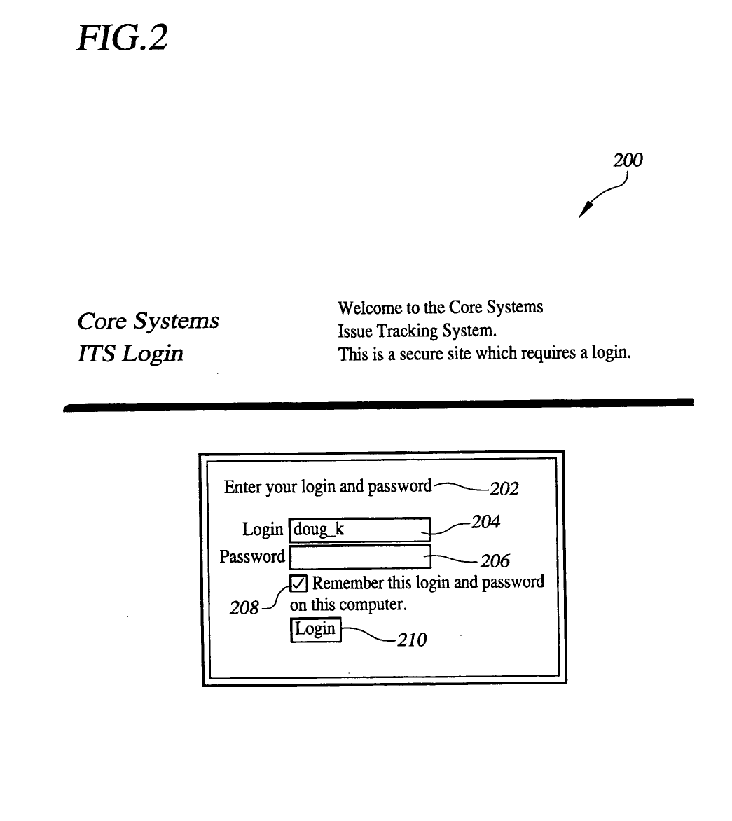

The issue tracking system 152 is a research and development tool that enables software and/or hardware engineers, QC (Quality Control) or QA (Quality Assurance) personnel, management, or other personnel, to enter, view, and manipulate issues. There are varying levels of access. When a user is first introduced to the issue tracking system 152, an account is created for him or her that requires a log-in and password. At that point, the user has predetermined access restrictions to the issue tracking system 152. FIG. 2 is a screen diagram of an exemplar log-in screen 200. The exemplar log-in screen 200 includes an instruction line 202, a log-in entry window 204, a password entry window 206, a recall window 208, and a log-in button icon 210. The instruction line 202 instructs the user to enter his or her log-in name in the log-in entry window 204 and his or her password in the password entry window 206. The recall window 208 can be selected with a mouse pointer, tabbed to using a tab button on a keyboard, or other well-known navigation tools. The user selects the recall window 208 when he or she desires to have his or her log-in and password to be defaulted to on the data entry device the user is currently using (e.g., workstations 116a-c, FIG. 1A). Further, by selecting the recall window 208 (represented by the check mark in the window), the issue tracking system 152 (FIG. 1B), using “cookies,” remembers the last screen or page that the log-in user was looking for and displays that page.

Regarding the various levels of access, at a low level is a contributor access level, which enables a contributor to submit issues to the issue tracking system 152. For example, a QA person may be hired for a particular product or product line, and responsive to detecting an issue, submits the issue to the issue tracking system 152 (FIG. 1B). The QA person thus can submit and view defects that they have submitted.

A higher level of access may be a team member access level. For example, organizations may have one or more projects that include engineers, and each engineer is provided with the capability to submit issues, the capability to be assigned issues, and the capability to resolve the issues.

A project manager or project administrator access level provides for report viewing and generation, which can be routed to various levels of management. For example, such reports may be useful to determine the quantity of issues that are outstanding, the average severity of the issues, and/or whether issues are occurring at a faster rate than they are being resolved.

Finally, the top of the hierarchical levels is the super-user, which may be granted to a system administrator, or the capabilities can be provided to a section manager, for example. Responsibilities of a person at this level of access include the ability to create, modify, review, and/or delete one or more projects.

Thus, based on the assigned log-in and password, a person is granted a predetermined access level to the issue tracking system 152 (FIG. 1B).

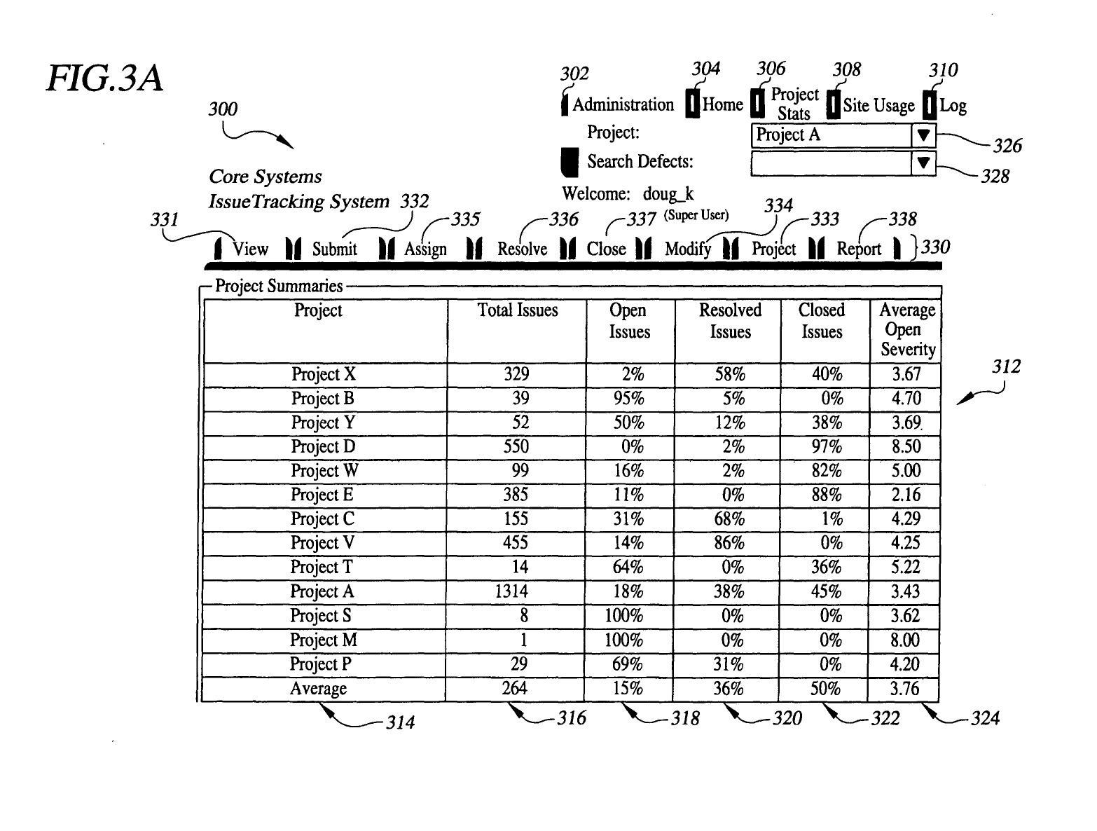

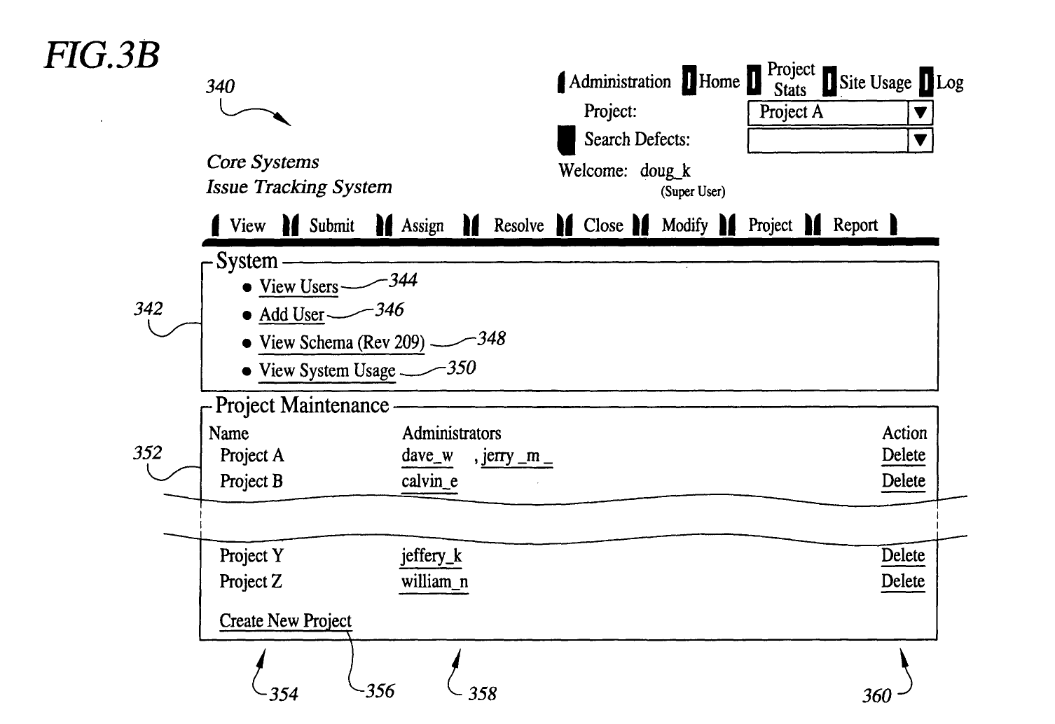

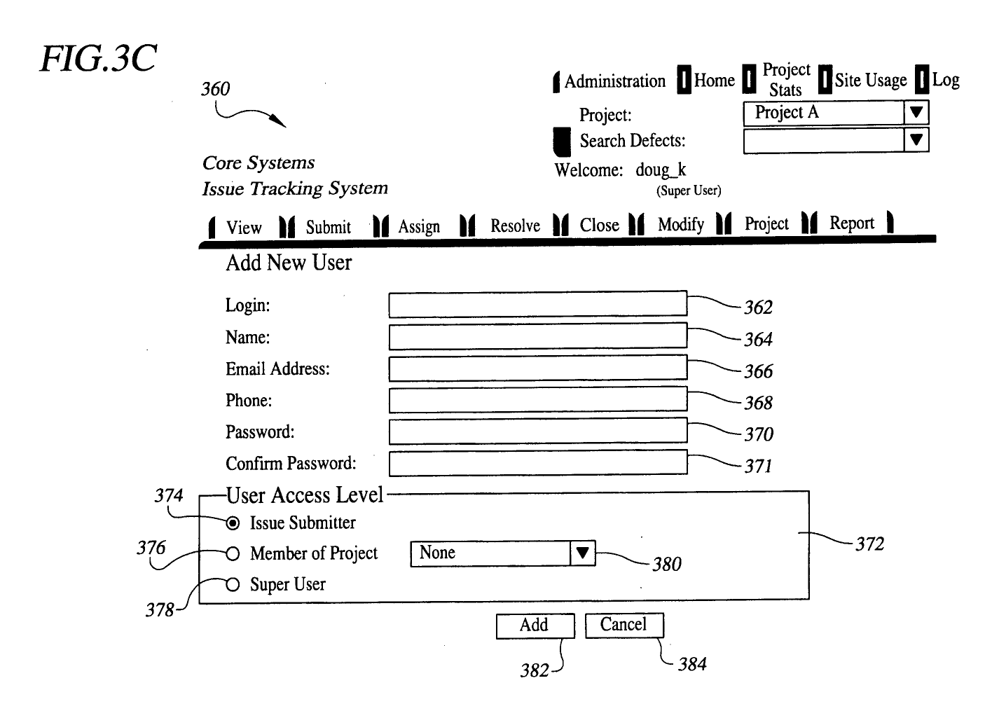

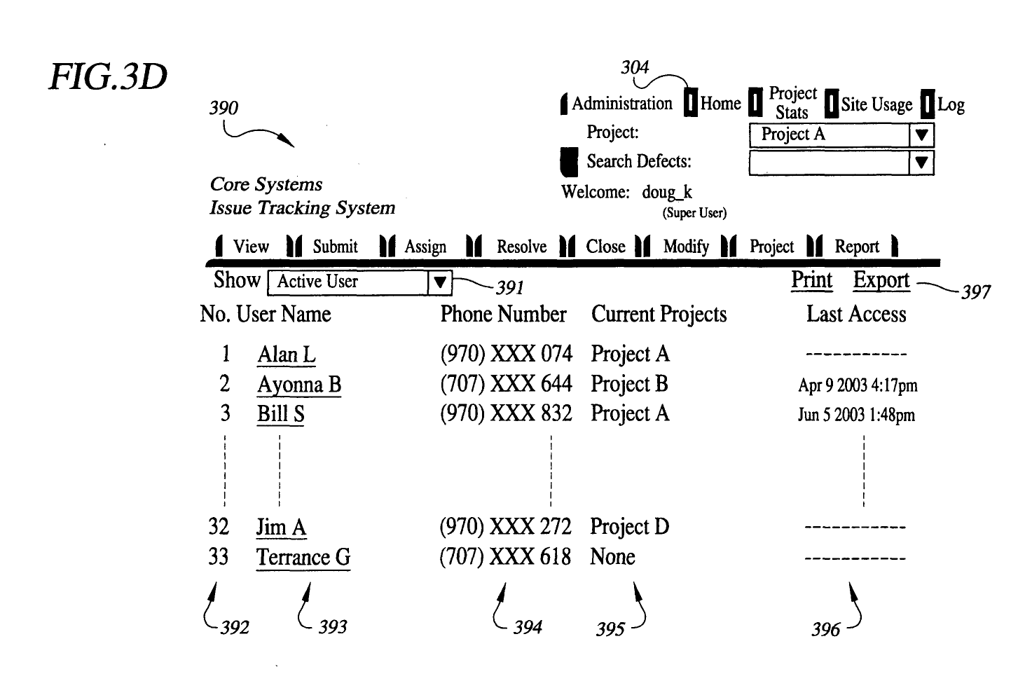

FIG. 3A is a screen diagram of an exemplar home screen 300 for the issue tracking system 152 (FIG. 1B). The home screen 300 includes several tab icons, including an administration tab icon 302, a home tab icon 304, a project stats tab icon 306, a site usage tab icon 308, and a log tab icon 310. The exemplar home screen 300 also includes a project window 326, which provides a drop-down menu of projects, and a search window 328 used for searching for issues (e.g., improvements and/or defects). Additionally, the exemplar home screen 300 includes a tool-bar 330, which includes a view tab icon 331, a submit tab icon 332, an assign tab icon 335, a resolve tab icon 336, a close tab icon 337, a modify tab icon 334, a project tab icon 333, and a report tab icon 338. The tab icons 331-338 will be described below in association with different screens. One or more of these tab icons 331-338 may be omitted from some user screens, depending on the access level of a particular user. For example, a person who submits issues generally will have only the view tab icon 331 and the submit tab icon 332. A member of a project, for example, may have the tab icons 331, 332, 335, 336, 337, and 334, but not the tab icons 333 and 338. A project administrator on the other hand may have all of the tab icons displayed across the screens he or she uses. All of the features of the exemplar home screen 300 listed above (302-310, 326-338) are included in subsequent screens as well.

The administration tab icon 302 is restricted to the super-user, and whoever else is authorized by the super-user or other administration official. The administration tab icon 302 is accessed by a super-user to set-up and create projects, handle user accounts, among other functions described below. FIG. 3B is an exemplar administration screen 340 responsively displayed by selecting the administration tab icon 302 (FIG. 3A). The administration screen 340 includes a system view section 342 and a project maintenance section 352. The system view section 342 includes a view users icon 344, an add user icon 346, a view schema icon 348, and a view system usage icon 350. The view users icon 344 and add user icon 346, when selected, enable the administrator to view the users of a particular project, and add users, respectively. The view system usage icon 350, when selected, provides information about system usage.

The project maintenance section 352 includes a project name column 354 that lists the active project names, a project administrator column 358 that lists the project administrator corresponding to the project name, and an action item column 360 that enables the administrator to delete the various projects. The project maintenance section 352 also includes a create new project icon 356, which, when selected, displays a screen (not shown) to the administrator that enables the creation of a new project. Such a screen may include the name of the project and various button icons to enter additional information and/or navigate to another screen.

As indicated above, the administrator may be provided with a list of names (e.g., new employees) that require the creation of new accounts. Selecting the add user icon 346, the administrator is responsively presented an exemplar add user screen 360 as shown in FIG. 3C. The add user screen 360 includes a log-in window 362 to create a log-in address for the new user, a name window 364, email address window 366, phone window 368, and password window 370 to enter the name, email address, phone number, and password, respectively, for the new user. A confirm password window 371 provides a way for the administrator to confirm (e.g., by typing in the password again) the password entered in window 370.

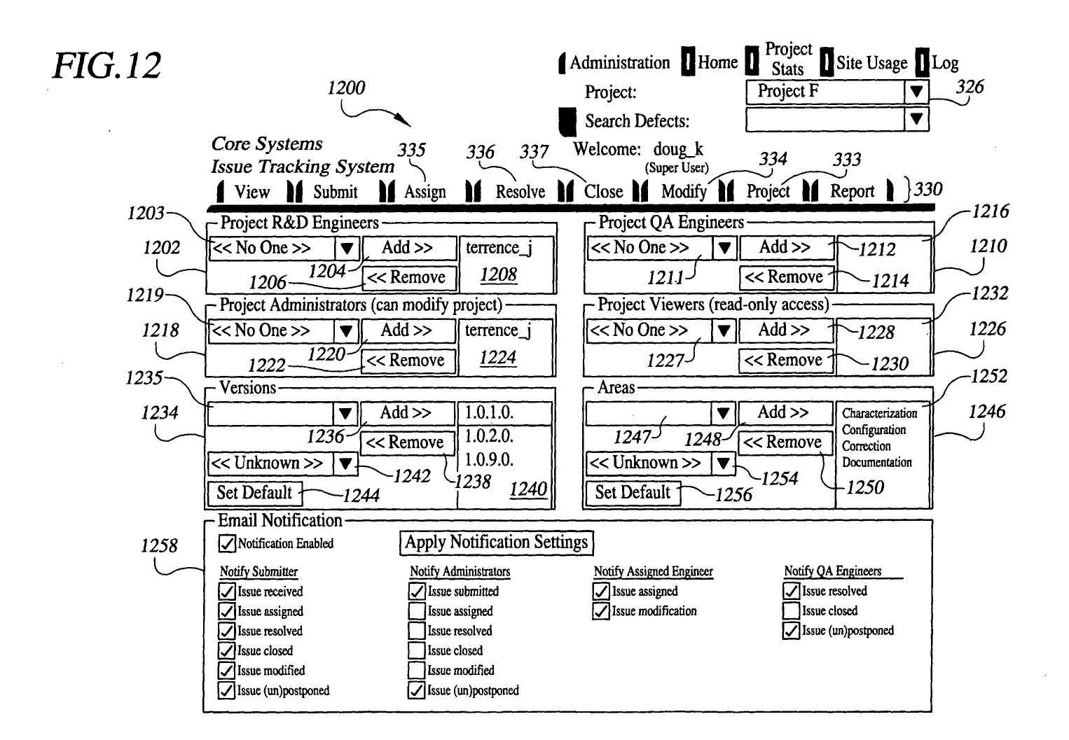

The add user screen 360 also enables the administrator to set-up the level of access for the new user. The user access level section 372 is the section of the add user screen 360 that enables this set-up to occur. The user access level section 372 includes an issue submitter check icon 374, a project member check icon 376, and a super-user check icon 378 that establishes the level of access for the new user. A selection made in one of these check icons 374-378 is displayed in the access level window 380. The administrator can also add this new user to a particular project at this point by selecting the add user button icon 382. The screen displayed in response to selecting the add user button icon 382 can be, for example, screen 1200 (see FIG. 12, described below). Additionally, the administrator may access the add user screen 360 to cancel a user (e.g., a retired employee) by selecting the cancel button icon 384.

Referring to FIG. 3B, the administrator can also select the view system usage icon 350 to display an exemplar system usage screen 390, as shown in FIG. 3D. The system usage screen 390 provides a list of all of the users of the issue tracking system 152 (FIG. 1B). The system usage screen 390 includes a display configuration window 391, a list number column 392, a user name column 393, a phone number column 394, a current projects column 395, and a last access.,column 396. The system usage screen also includes an export icon 397. The display configuration window 391 includes a selection of active users for this example, and thus the list of users in the user name column 393 will be the names of active users. The list number column 392 consecutively numbers the list of active users. The user name column 393, phone number column 394, and current projects column 395 include the user name, phone number, and list of projects of which the user is associated. The last access column 396 provides an indication to the administrator as to when the user last accessed the issue tracking system 152.

The export icon 397, when selected, provides a mechanism by which the list of information in the columns can be formatted into an Excel spreadsheet.

The home tab icon 304 can be selected to prompt the display of the exemplar home screen 300 (FIG. 3A). Referring to FIG. 3A, the project stats tab icon 306 is selected to enable an authorized person, for example a section manager, to obtain a “snapshot” of all projects, similar to the project summary chart 312.

The log tab icon 310 enables a system administrator to select any user of the system, which prompts an additional window (not shown) to be displayed. This additional window provides a complete log of what the user has done while in the system over a predetermined amount of time (e.g., over thirty days, for example). Such a log can provide a system administrator with user habits while in the system, enabling fine-tuning of a use model that minimizes the effort involved in using the issue tracking system 152 (FIG. 1B).

The user can deploy a drop-down menu of projects by selecting the arrow icon of the project window 326. The drop down menu lists the projects shown in the exemplar home screen 300. A user may have access to one or more projects. To access a particular project, such as Project E, the user selects Project E from the drop down menu. The user can also type in the name of the project if he or she knows the name. Note that the display of projects (and thus accessibility to those projects) in the drop down menu can be based on the level of access corresponding to the user log-in (e.g., at the exemplar log-in screen 200 of FIG. 2). For example, if the user is a member of Project E and Project D, then he or she will only see those two projects in the drop down menu. Variations of this feature may be provided. For example, a super-user has access to all projects, and thus the drop down menu of the person logged in as a super-user can display all projects.

The project summary chart 312 includes a project name column 314, a total issues column 316, an open issues column 318, a resolved issues column 320, a closed issues column 322, and an average open severity column 324. As represented by the project name column 314, there are several projects in this example with titles including Project A, Project B, Project C, Project D, and Project E, among others. A project could be a series of “sub-projects” (e.g., Project A, B, C, and D could all be related as various aspects to one software project), or the projects corresponding to the project names listed in the project name column 314 could be separate (e.g., a software project for Project A, a hardware project for Project B). As would be understood by those having ordinary skill in the art, more descriptive titles for the project names can be used. Further, one having ordinary skill in the art would understand that the column-and-row categories for this screen 300, and other screens described herein, can be arranged as row-and-column categories in other embodiments.

The total issues column 316 provides the quantity of issues for each respective project. For example, Project A clearly has the most issues, which may convey to a user that it is a project that is receiving a lot of attention. The open issues column 318 provides an indication that the respective project has been submitted and is pending either assignment or has been assigned and is currently under review.

A resolved issue in the resolved issues column 320 represents that the person assigned to resolving the issue has affirmed that the issue has been resolved. The closed issue in the closed issues column 322 represents that resolution of the issue by the person assigned to resolve the issue has been independently verified.

Care is to be exercised in interpreting the values in each of these columns because each project can be in various stages of development when compared to other projects. For example, consider Project B, which shows 95% in the open issues column 318 and 5% in the resolved issues column 320. These figures imply that either the issues have been submitted recently, or that the issues are not addressed in an expeditious manner. As another example, Project C has 31% in the open issues column 318 and 68% in the resolved issues column 320. In other words, 31% of the issues are being reviewed and 68% of the issues have been addressed (e.g., defects were corrected). Thus, Project C is probably a fairly mature project, whereas, assuming best efforts, Project B is a fairly recent project. As another example, Project D appears to be finished, since there are no open issues. There are 550 issues (total issues column 316) with 2% resolved (resolved issues column 320) and 97% have been closed (closed issues column 322). Note that the numbers shown in this example are rounded, and thus summation to 100% may not be shown despite expectations from the figures constituting the sums. The fact that 97% of the issues have been closed for Project D represents that this project is about completed.

The average open severity column 324 represents a number that is included within a scale for the magnitude of an issue (e.g., for a defect, the severity of the defect). Average open severity is comprised of three components: frequency, consequence, and work-around. The frequency component provides an indication of how frequent the issue occurs. The consequence component describes the severity of the problem once the issue occurs. The work-around component is a measure of the complexity in circumventing the issue. Thus, average open severity is determined by the summation of the frequency and consequence component less the work-around component.

For example, one range for average severity (and each component of average severity) can be 0-9, with “0” representing a minor defect and “9” equating to significant problems (e.g., do not ship the product). For example, a user can attempt to run an installation software package to install software and the computer “crashes”, preventing the installation of the software. That scenario represents a fairly significant issue that might be deserving of a “9” ranking. Note that a project, like Project D, has a ranking of 8.5, which equates to issues submitted of primarily a “9” ranking. Such may be the case where only critical-type issues are submitted (e.g., some threshold level of criticality was exercised before submitting issues). The value of the average severity number in the average open severity column 324 is that of providing awareness. For example, a value of 8.5 might suggest that almost every issue submitted was critical, whereas a value of 3 prompts less concern. Note that the values in the average open severity column 324 refer to only the issues that are currently open. For example, the 8.5% average severity in the average open severity column 324 for Project D may reflect that there is only one open issue, but one divided by five hundred fifty is close to 0% when rounded (or rather, that there are two open issues (one at 9 and one at 8)). Thus, from the exemplar home screen 300, a high-level manager can get a glimpse or snapshot of all the projects and the status of, each.

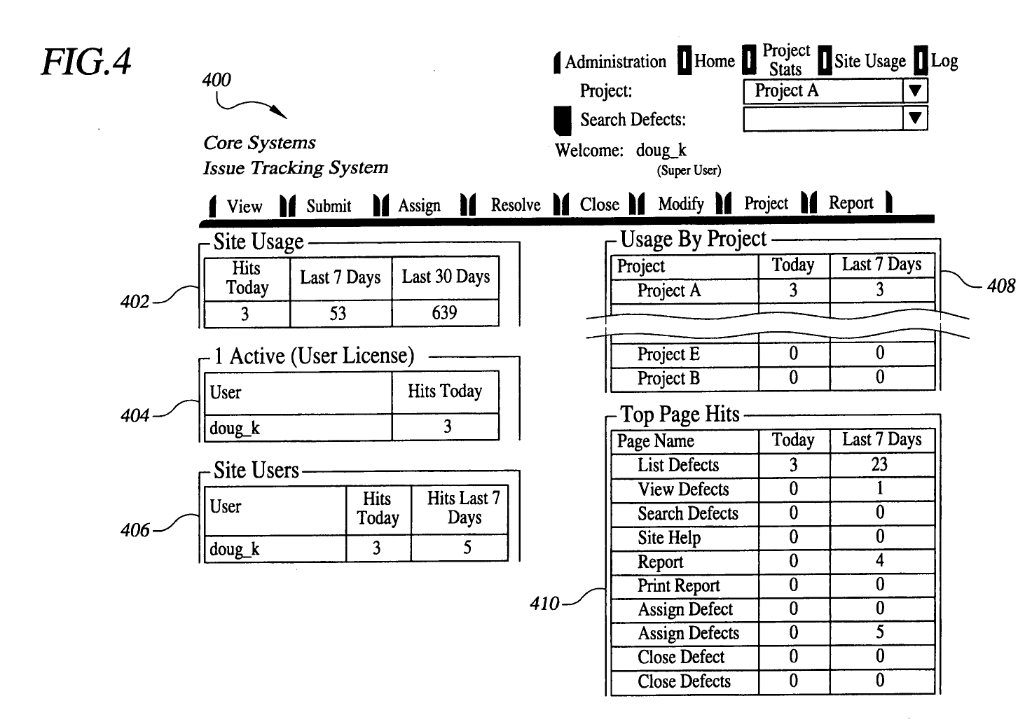

The site usage tab icon 308 can be useful for an administrator. The site usage tab icon 308 conveys information on the frequency of activity for a particular site. FIG. 4 is a screen diagram of a site usage screen 400 displayed in response to a user selecting the site usage tab icon 308 (FIG. 3A) from the exemplar home screen 300 (FIG. 3A). The discussion of features of the exemplar home screen 300 that are shown in later described screens (e.g., such as the site usage screen 400) are omitted for the sake of brevity. The site usage screen 400 provides the frequency of activity for the screen from which it was prompted (e.g., in this example, the exemplar home screen 300). The site usage screen 400 includes a hits-history window 402, a current user history window 404, a site user history window 406, a usage by project history window 408, and a top page hits window 410.

The hits-history window 402 provides a measure of the frequency of visits to the exemplar home screen 300 (FIG. 3A) for the current day, the last 7 days, and the last 30 days. For example, in the last 7 days, there have been fifty-three hits to the exemplar home screen 300, and in the last 30 days, six hundred thirty-nine. The current user history window 404 provides a measure of the frequency of visits to the home screen 300 for the current day by users currently logged into the issue tracking system 152 (FIG. 1B), as well as the name of the currently logged in user or users. As shown in this example, only one user is currently logged into the issue tracking system 152. The site user history window 406 provides a measure of the frequency of visits to the home screen 300 by the user associated with the terminal displaying this screen for the current day and for the last 7 days. Note that one skilled in the art would understand that different integrals or periods of measurement (e.g., last ten days as opposed to last seven days) can be used in other embodiments.

The usage by project history window 408 provides the project name, the frequency of usage for the current day, and the frequency of usage for the last seven days. As shown in this example, Project A shows the most activity of this abbreviated list (the abbreviated nature of the list represented by the parallel, wavy lines across the columns of 408) in the last seven days. The top page hits window 410 provides information that can be used by the administrator to further tailor the page for ease of use. All of the pages in the issue tracking system 152 (FIG. 1B) have a title (as shown in the page name column of the top page hits window 410), and thus activity can be monitored to determine which pages to possibly modify to, for example, make the page more user-friendly.

Note that the arrangement of icons and other components or features shown in the exemplar screen diagrams are for illustration, and one skilled in the art would understand in the context of this disclosure that other arrangements can be used.

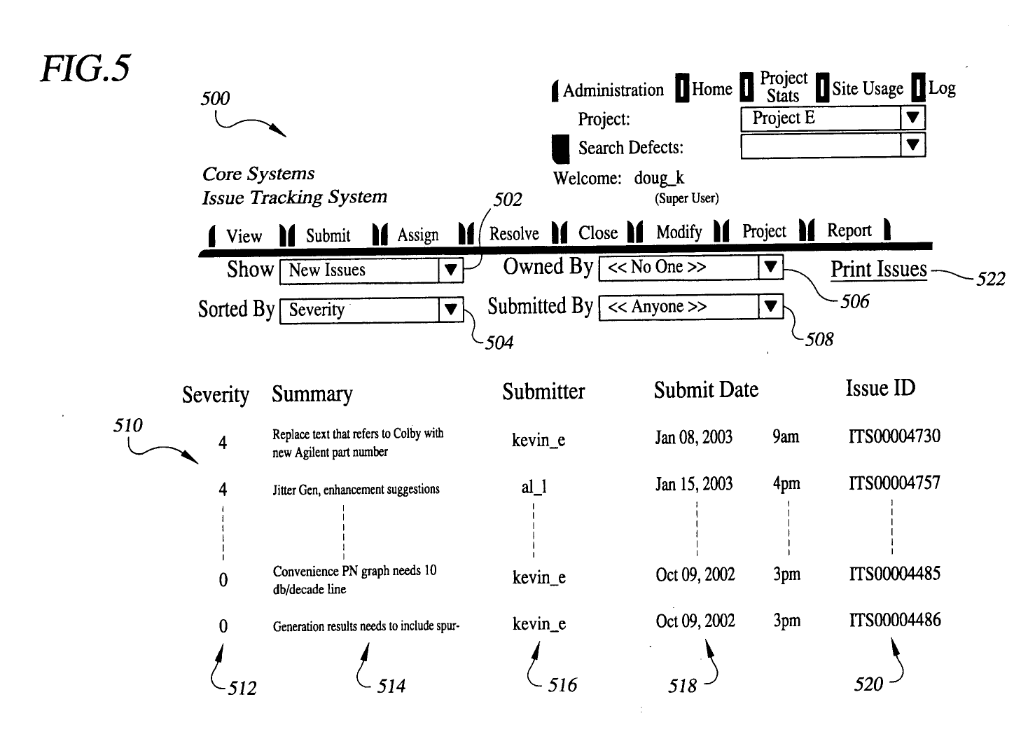

FIG. 5 is a screen diagram of an exemplar view issues screen 500. The exemplar view issues screen 500 can be displayed in response to a user selecting Project E from the drop down menu of the project window 328 (FIG. 3A). Note that the same or similar screen display can be prompted by a user selecting the view tab icon (e.g., view tab icon 331, FIG. 3A). The view issues screen 500 includes a display configuration window (labeled “show”) 502, a sort-by window 504, an ownership window 506, a submit-by window 508, and a summary section 510. The summary section 510 provides a summary report list of all the issues in that selected project (e.g., Project E). The summary section 510 includes several columns, including a severity rank column 512, a summary column 514, a submitter column 516, a submit date column 518, and an issue identification (ID) column 520. The exemplar view issues screen 500 also includes a print icon 522. The print icon 522 enables the user to print out printer-friendly versions for many of the various web pages (or screens) described for the issue tracking system 152. The printer-friendly version omits many of the non-essential features of the page such as the tab icons, etc.

The issues that are displayed are the result of a screening process that considers the drop-down menu selections of windows 502-508. For example, displayed in this screen 500 are the issues that are “new,” as indicated in the display configuration window 502. The ownership window 506 appears grayed out, and is described below. The selected sort is by severity (i.e., average severity), as shown by the selection in the sort-by window 504. Recall that severity is scaled from zero to nine. The severity of the project appears to reflect that the project is fairly mature, as noted by the lower severity numbers or rankings represented in the severity rank column 512.

The sort-by window 504 can also be selected to sort by other mechanisms, as suggested by the various column entries of the summary section 510. For example, a user can prompt the drop-down menu of the sort-by window 504 to select “sort-by-submitter (e.g., the person who typically discovers the defect) (not shown). The ability to perform this sort is suggested by the submitter column 516. Responsive to a selection of “sort-by-submitter” in the sort-by window 504, the columns re-order (not shown). Note that the names listed in the submitter column 516 are formatted as email links to the submitter.

Another option for sorting is by issue identification (ID). Issue ID is the unique identifier of an issue, as shown by the entries in the issue ID column 520. Issues recorded for a specified project have a number associated with it. For example, shown in the issue ID column 520 is a three-letter name prefix followed by a multi-digit number that is incremented whenever there is a new issue. Another sort option includes the submit date, as reflected by the submit date column 518. The submit date for a particular issue provides the user with an indication of the age of the issue. Such a sort may assist management or others in avoiding the possibility of issues not receiving enough attention.

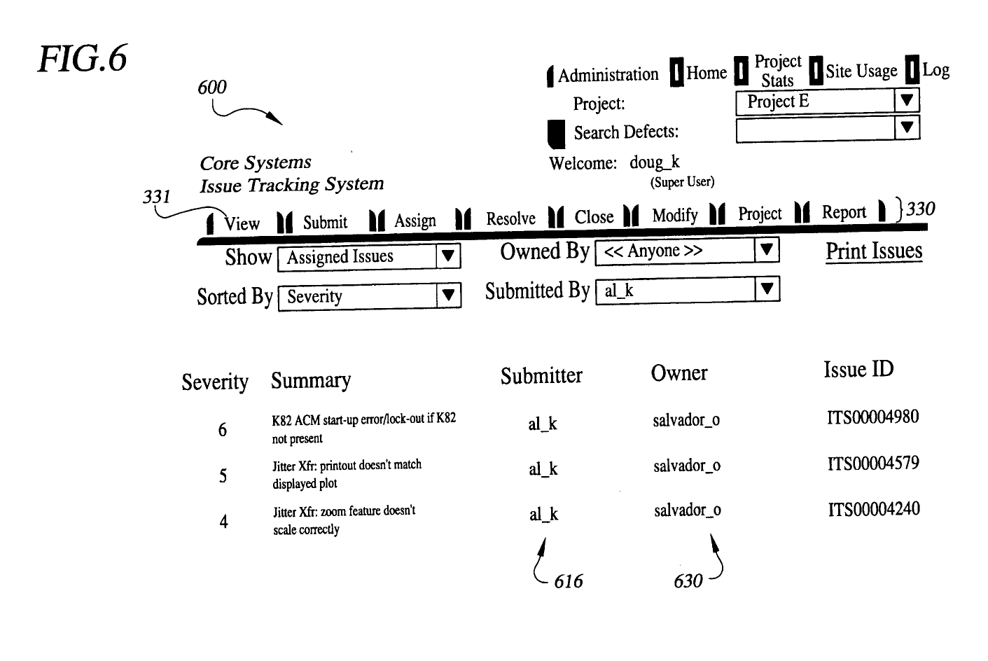

FIG. 6 is a screen diagram of an exemplar view issues screen 600 based on changing the selections in the windows 502-508 of FIG. 5. In other words, assume the user maintained the selections in the sort-by window 504 and the ownership window 506, but changed the selection in the display configuration window 502 to “assigned issues” and changed the selection in the submit-by window 508 to “al_k.” The view issues screen 600 illustrates a sort by “assigned issues” (e.g., issues that are past the submit stage), wherein the assigned issues are submitted by al_k. For example, an engineer on a particular project team has “ownership,” or responsibility, for the issue (e.g., responsible for resolving the issue). As shown, a submitter column 616 shows al_k as the submitter. Further, an ownership column 630 is displayed, and the ownership column 630 provides the name of the owner or person responsible for resolving the issues.

Further screening or refinement can be implemented. For example, a sort can be performed by selecting to show the assigned issues to salvador_o. Responsively, the list is re-configured to display (not shown) only those issues assigned to salvador_o (not shown). As another example, a sort can be implemented wherein the submitter is al_{—}1, or others. Further, a sort can be performed by selecting “owned by” a particular engineer (not shown).

The default screen shows the issues assigned to the user (based on his or her log-in), although other default screens can be configured. There is a shortcut entitled, “me” (not shown). The user “me” aliases to the particular user who logged into the issue tracking system 152 (FIG. 1B). For example, Engineer A1 L (corresponding to email link al_{—}1) logs in, and responsive to the log-in, the default screen shows issues assigned to “me”, wherein “me” is A1 L. For a different user, “me” is his or her defects.

The issue tracking system 152 (FIG. 1B) enables a user to manipulate various aspects of the issues of a project to provide helpful information about the nature of the issues, projects, and/or project members. The user interfaces of the issue tracking system 152 are task-oriented, unlike prior art issue tracking systems. The issue tracking system 152 enables personnel to view and/or evaluate issues that are most relevant to them, as opposed to being exposed to hundreds of issues that have little to no relevance to them. The description that follows will focus on components of the tool bar 330 (FIG. 6).

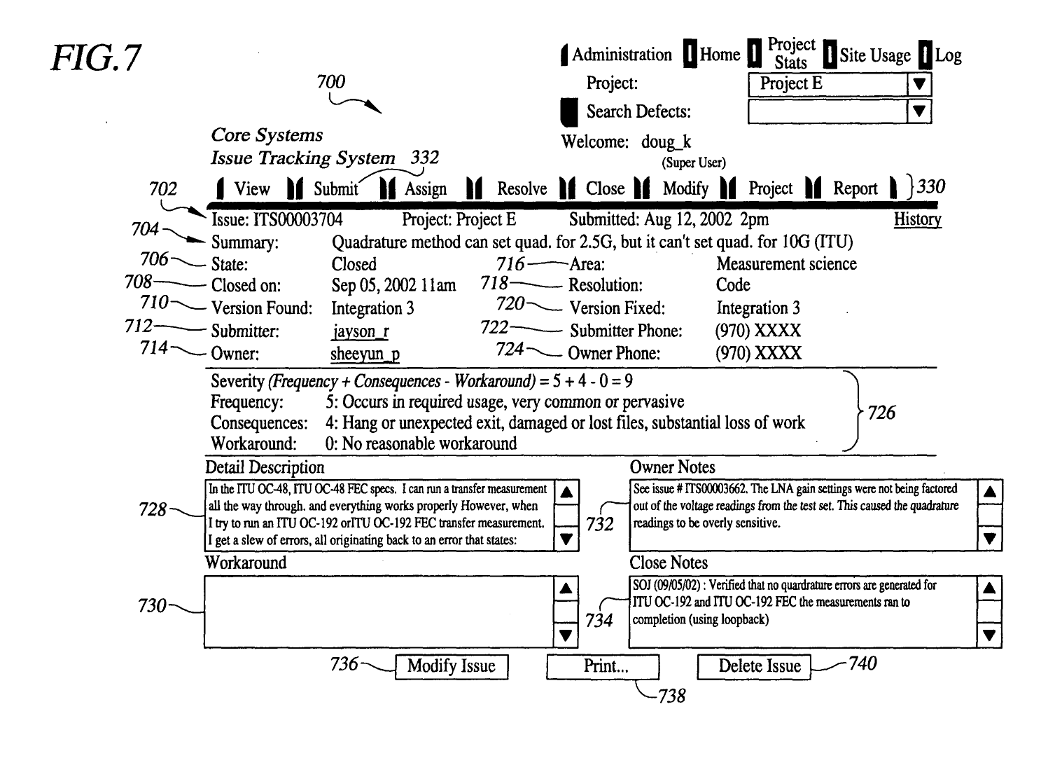

Referring to FIG. 6, a view tab icon 331 of the tool bar 330 can be selected, which responsively displays a view issues screen 700, as shown in FIG. 7. The view issues screen 700 provides specific details for an issue. The view issues screen 700 includes an information line 702, a summary line 704, and various status lines. The status lines include status on state 706, when closed 708, version 710, submitter 712, owner 714, area 716, resolution 718, version fixed 720, submitter phone 722, and owner phone 724. The view issues screen 700 also includes an average severity section 726, a detailed description window 728, a work-around window 730, an owner notes window 732, and a close notes window 734. Further, the view issues screen 700 includes a modify issue button icon 736, a print button icon 738, and a delete issue button icon 740.

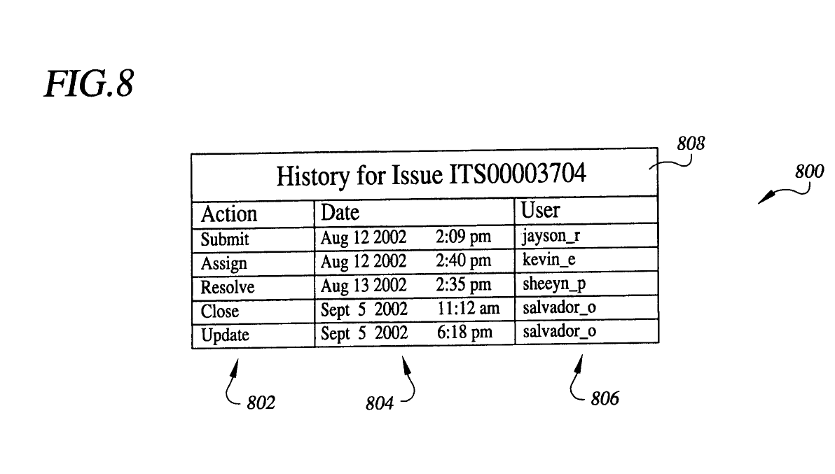

The information line 702 can include, for example, the issue ID, the project the issue ID is associated with, when the issue was submitted, and a history icon. The history icon provides an option to obtain a complete history of processing of the issue. By selecting the history icon, a pop-up window is provided showing the history of the issue). FIG. 8 is a screen diagram of an exemplar history pop-up window 800 responsively displayed upon the user selecting the history icon in the information line 702 (FIG. 7). The history pop-up window 800 includes a header 808 providing the identity of the issue (i.e., the issue ID), an action column 802, a date column 804, and a user column 806. The action column 802 includes the action taken (e.g., an issue is submitted, assigned, resolved, closed, updated, etc.) The date column 804 provides a date and/or time when the action occurred. The user column 806 provides the name of the user who performed the stated action.

For example, on Aug. 12^{th}, at 2:09 PM, a user by the name of jayson_r (from user column 806) submitted this particular issue having issue ID ITS00003704 (from the header 808). This defect was assigned 31 minutes later by kevin_e (from the date column 804 and user column 806) and was resolved the next day by sheeyun_p. Three weeks later, the issue was closed by salvador_o, and that same day, salvador_o modified the issue (perhaps by placing more information into it).

Referring back to FIG. 7, basic information is provided for this issue, such as the information provided in the summary line 704, as well as the state the issue is in (state status line 706). As shown by the state status line 706, the issue is closed, and in fact was closed on Sep. 5, 2002 (as indicated by the when-closed status line 708). The version status line 710 is applicable generally to code, and is used to identify the version number associated with the issue. The submitter status line 712 and the owner status line 714 provide the name of the submitter of the issue, and the person with whom responsibility for the resolution of the issue lies, respectively. Note that the names in the submitter and owner status lines (712 and 714) are links that can be selected to provide an automatic connection to an email system.

The area represented in the area status line 716 is a defined set of enumerated values that when a project is created, there are sub-projects associated with it. For example, if a group was to create a piece of software, the software can be further sub-divided into installation software, user interface (UI) software, measurement software, etc. Thus, when a project is created, there may be sub-projects created that correspond to the sub-divided software categories. Issues can be associated with a particular sub-project. The resolution status line 718 provides information regarding the type of technology used to resolve the issue. In this example, software code was used to resolve the issue. Other resolutions can include correcting documentation, correct operator error, among others. The version fixed status line 720 includes the software version to which the resolution was directed. The submitter phone status line 722 and the owner phone status line 724 provide the contact information for the submitter and owner, respectively.

The average severity section 726 provides information on the average severity of the identified issue, and the values or rankings of the individual components that comprise the average severity number as well as the ranking of the average severity number. Further, additional information is provided next to each ranking for the component portions to provide the user with an indication as to the meanings of the rankings.

The detailed description window 728, work-around window 730, owner notes window 732, and close notes window 734 are read-only fields that provide the user with additional information about the issue. Although not shown here, one or more of these windows can include file attachments. The titles of each window are self-explanatory, and thus corresponding description is omitted here for brevity.

The button icons 736-740 may vary depending on the screen, the state of the issue, and/or the access level of the user. The button icons 736-740 are generally configured to provide a mechanism that is most useful for the particular screen for that particular user. For example, it will generally be the case that the print button icon 738 is included in the view issues screen 700 since a user will generally want a printer-friendly version of the issue. Notes included in the windows 728-734 are printed without the scroll bars. The delete issue button icon 740, on the other hand, is generally restricted to screens of a super-user, as it is unlikely that an organization wants everyone to be able to delete defects from the issue tracking system 152 (FIG. 1B). The modify issue button icon 736 enables the user to go in and change the content or information of one or more of these window fields (e.g., windows 728-734). In other words, an edit screen is prompted (not shown) in response to a user selecting the modify issue button icon 736. Note that some windows in the edit screen may be grayed-out to prevent unauthorized edits. Also, file attachments can be added to one or more of these windows from the edit screen. Note that a user can also select the history icon in the information line 702 to view who provided changes to the record of this issue as well as the date that he or she made that change.

As indicated above, the button icons 736-740 may differ depending on the state of the issue. For example, since the issue associated with this screen 700 is closed, operations are generally limited to printing and modifying information for the corresponding record (and thus the display and availability of the print button icon 738 and the modify issue button icon 736). If this issue was just submitted, an additional button icon can be an “assigned” button icon (not shown) for assignment to an engineer or other personnel. Further, if the state of the issue was that it was already assigned, an assigned button icon would be replaced with a resolved button icon (not shown). If resolved, then the resolved button icon may be replaced with a closed button icon (not shown). In some embodiments, one or more of these button icons can be displayed at once.

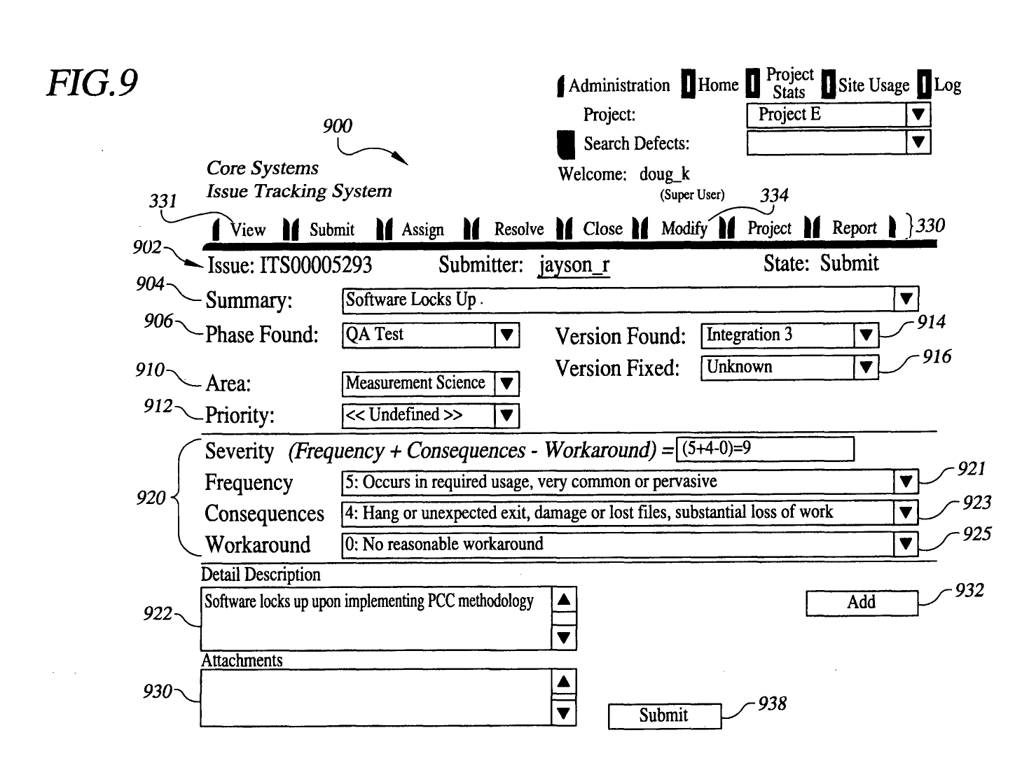

Another component of interest in the tool bar 330 (FIG. 7) is the submit tab icon 332 (FIG. 7). The submit tab icon 332, when selected, responsively provides an exemplar submit screen 900 (FIG. 9) where the user can submit information in a prior submitted issue. The submit screen 900 includes an information line 902, a summary window 904, a phase found window 906, an area window 910, a priority window 912, a version found window 914, and a version fixed window 916. Further, the submit screen 900 includes an average severity section 920 that includes a frequency window 921, a consequence window 923, and a work-around window 925. The submit screen 900 also includes a detailed description window 922 and an attachments window 930. In addition, the submit screen 900 includes an add button icon 932 to add an attachment to the attachment window 930, and a submit button icon 938 to submit the issue.

As shown, the information line 902 includes the issue ID, the submitter, and the status. The status is in the submit stage. Note that, as is true for one or more of the screens described herein, certain fields may be highlighted in red or otherwise distinctively designated as fields where input is required (e.g., mandatory fields). For example, the summary window 904 may be highlighted or colored in red or some other color, thus signifying that a submitter must enter a brief description or summary of the issue, and failure to do so may prohibit the user from submitting a issue. In this case, the submitter has detected a software-glitch when implementing a specified methodology, and thus has entered this information in the summary window 904. Note that the display of settings are consistent with data for Project E, as that is the project from which the user selected the submit tab icon 332 (FIG. 7). In other words, upon selecting the submit tab icon 332, the user is presented with a submit issue screen 900 that defaults to the project (e.g., Project E) from which the user invoked the screen 900.

The phase found window 906 provides a mechanism for the submitter to enter the phase of a project during which the issue was detected. In this example, the user selects (or enters) “QA Test” as the phase during which the issue was detected. The issue was in the area of measurement science, and thus the user selects this option from the area window 910. The priority window 912 shows that the priority remains undefined. The version found window 914 indicates the version of the software corresponding to the software code problem, although the version fixed is unknown at this point (as indicated by “unknown” selected in the version fixed window 916). The average severity section 920 includes windows 921, 923, and 925 that can be altered using the drop down menus corresponding to each window. The user thus is describing the severity in real-world terms or common language, and the average severity is calculated “on-the-fly” based on the selected information.

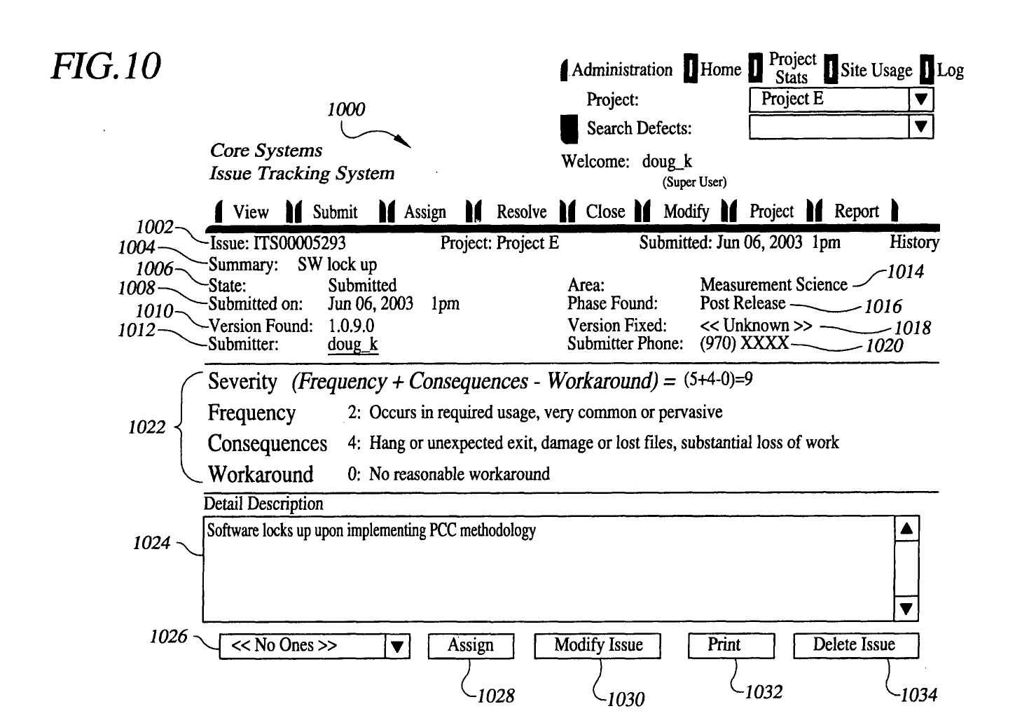

Additionally, the user can enter text in the detailed description window 922 to provide further information on the nature of the issue, in this case the software-glitch. Also, the user can include a file attachment in the attachments window 930, and add the attachment by selecting the add button icon 932. When the user has completed entering information to the submit issue screen 900, the user selects the submit button icon 938. In response to this last selection, the user is presented with a view issues screen (not shown) that is similar in appearance and features to that shown for FIG. 5. The default project will be the project the user submitted the issue to, and the last issue entered is highlighted. From that un-shown screen and while highlighted on the last entered issue, the user can select the view issues tab icon (e.g., 331 in FIG. 6), and a view issues screen 1000 is displayed as shown in FIG. 10.

Another consequence of the user selecting the submit button icon 938 in FIG. 9 is that an email message is automatically generated and sent to the project administrator for the project in which the issue was submitted (e.g., Project E). This function will be described further below.

The view issues screen 1000 in FIG. 10 includes the issue ID of the defect the user last entered, the project name, and the submission date in an information line 1002. The view issues screen 1000 also includes a summary line 1004 that provides a brief description of the problem, a state line 1006 that shows it is in the submit stage, and a submitted-on line 1008 that provides the date of submission. The view issues screen 1000 also includes what version of the software the issue was detected in the version found line 1010, the name of the submitter in the submitter line 1012 (the name being an email link), the area of the issue (measurement science as indicated by the area line 1014), and what phase the issue was found (phase line 1016). The entry in the version fixed line 1018 is unknown at this time, likely because the issue has not been addressed. The submitter phone line 1020 provides the submitter's phone number.

The view issues screen 1000 also includes an average severity section 1022 that shows the average severity entered in the submit screen 900 (FIG. 9), and a detailed description window 1024 also reflecting the information entered in the submit screen 900. Further, the view issues screen 1000 includes an assign button icon 1028, and an assignment window 1026 that shows the name of the person the user entered after the user assigns the issue. Also included is a modify issue button icon 1030 to modify the information regarding the issue, a print button icon 1032, and a delete issue button icon 1034 to delete the issue record. Note that, as explained above, the screen layout is achieved in a “smart” manner in anticipation of the expected features the user would need at this stage or phase of the processing of the issue.

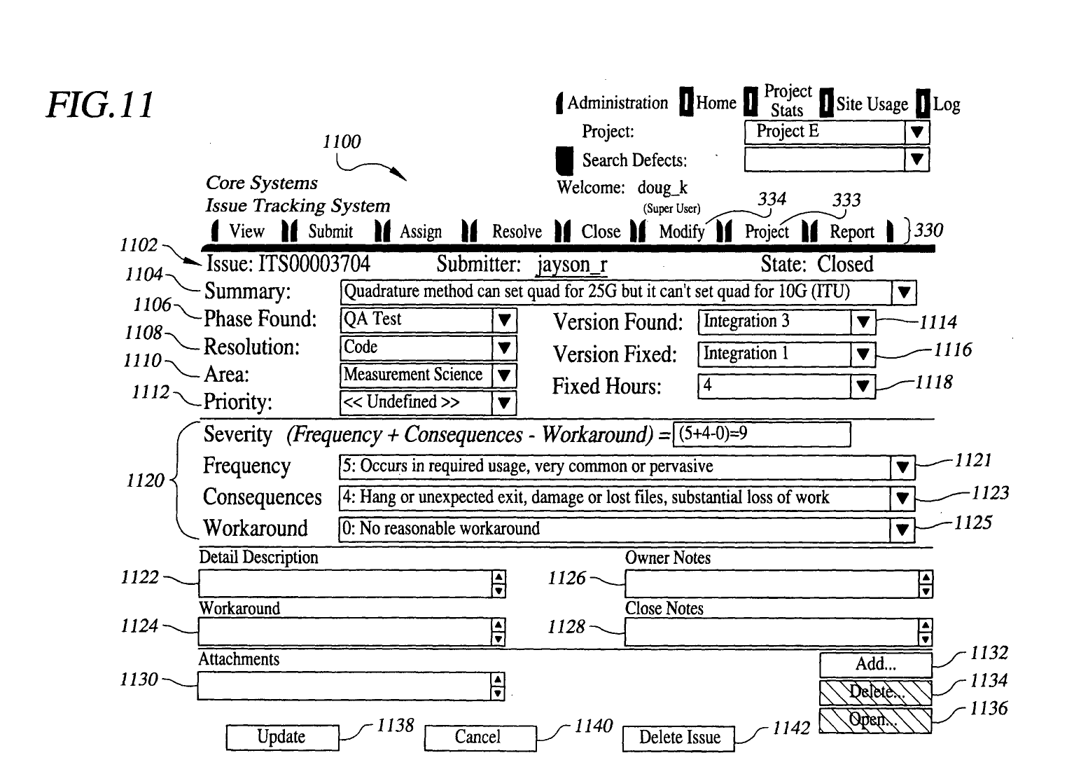

FIG. 11 is a screen diagram of an exemplar modify screen 1100. The modify screen 1100 can be displayed in response to selecting the modify issue button icon 1030 in the view issues screen 1000 of FIG. 10. The modify screen 1100 enables a user to modify information previously submitted and entered in a prior screen. The modify screen 1100 includes an information line 1102, a summary window 1104, a phase found window 1106, a resolution window 1108, an area window 1110, a priority window 1112, a version found window 1114, a version fixed window 1116, and a fix hours window 1118. Further, the modify screen 1100 includes an average severity section 1120 that includes a frequency window 1121, a consequence window 1123, and a work-around window 1125. The modify screen 1100 also includes a detailed description window 1122, a work-around window 1124, an owners notes window 1126, a close notes window 1128, and an attachments window 1130. In addition, the modify screen 1100 includes an add button icon 1132, a delete button icon 1134, and an open button icon 1136.

As shown, the information line 1102 includes the issue ID, the submitter, and the status of the processing of the issue. The status is in the closed stage, although the user may seek to modify or add to one or more of the descriptions in windows 1122, 1124, 1126, and/or 1128. The summary line 1104 provides a brief summary of the issue. The phase found window 1106 indicates the phase of a project during which the issue was detected. The resolution window 1108 indicates that code was used for resolving the issue, and that the issue was in the area of measurement science (reflected by area window 1110). The priority window 1112 shows that the priority remains undefined. The version found window 1114, version fixed window 1116, and the fix hours window 1118 are grayed out, thus preventing modification. The average severity section 1120 includes windows 1121, 1123, and 1125, which can be altered using the drop down menus corresponding to each window. Additionally, the user can enter text in windows 1122-1128, and also include file attachments in the attachments window 1130.

Modifications are implemented by the user selecting the update button icon 1138, although the changes can be cancelled by selecting the cancel button icon 1140 or the issue can be deleted by selecting the delete button icon 1142. Note that the delete button icon 1134 and open button icon 1136 are rendered inoperable for this screen, as shown by the graying-out of these two button icons.

When a project is initiated in an organization, the super-user or system administrator generally creates the project name and designates a project administrator in cooperation with management. FIG. 12 is a screen diagram of an exemplar project screen 1200. The project screen 1200 includes a R&D engineer section 1202, a QA engineer section 1210, a project administrator section 1218, a project viewer section 1226, a version section 1234, an area section 1246, and an email notification section 1258. The R&D engineer section 1202 enables an administrator to add and remove R&D engineers from a specified project (e.g., the new Project F, as indicated in project window 326). The R&D engineer section 1202 includes a status window 1203 that indicates current R&D members of the project, an add button icon 1204 and a remove button icon 1206 to add or remove R&D members from the project, and worksheet 1208 that enables the administrator to view which R&D members he or she is adding to or removing from the project.

The QA engineer section 1210 includes similar functionality for adding and removing QA engineers from a project, including a status window 1211, an add button icon 1212, a remove button icon 1214, and a worksheet 1216. Project administrators can be designated in the project administrators section 1218, which also includes similar functional items such as a status window 1219, an add button icon 1220, a remove button icon 1222, and a worksheet 1224.

The project viewers section 1226 is a read-only section that enables selected individuals to be made aware of the various events of a project. Again, similar functionality to the aforementioned sections 1202, 1210, and 1218 are shown, including a status window 1227, an add button icon 1228, a remove button icon 1230, and a worksheet 1232.

The versions section 1234 also includes a status window 1235, an add button icon 1236, a remove button icon 1238, and a worksheet 1240, as well as a selection list window 1242 and a default setting button icon 1244. The versions section 1234 enables the user to select the version numbers of relevance for the project. The default setting button icon 1244 can be used to select a version number by default when the administrator knows that it can be of only one version type.

The areas section 1246 is similarly configured to the versions section 1234, including a status window 1247, an add button icon 1248, a remove button icon 1250, a worksheet 1252, a selection list window 1254, and a default setting button icon 1256. The areas encompassed by this project can be added to in this section (i.e., section 1246).

The email notification section 1258 provides a mechanism for the project administrator to apprise project members and others of the evolution of the issue through the various processing stages. Thus, selected personnel can get an email notification upon the initiation or completion of defined events (e.g., upon an issue being received, closed, submitted, etc.). For example, the project administrator (i.e., terrence_j) receives an email notification when an issue is submitted that provides information such as project name the issue was submitted to (e.g., in the email subject line), the issue ID, a brief summary, and a link (e.g., via a uniform resource locator, or URL) to a view defects page for that issue ID. Based on the selections made in the “notify administrator” column of the email notification system 1258, terrence_j will not receive another email notification unless the issue was postponed or unpostponed.

The email notification of the issue tracking system 152 (FIG. 1B) provides a project administrator with a virtual “to-do” list when he or she arrives to work, consistent with the task-oriented nature of the issue tracking system 152. The project administrator can review the summary and then assign, resolve (note that an issue is resolved by the person who has ownership of the issue), etc. Similar actions can occur via a view issues screen (e.g., view issues screen 700, FIG. 7), thus “shrinking” the list of “to-do's” in a convenient, task-oriented manner.

In this example, terrence_j is listed as the project administrator, as shown in the worksheet 1224. Responsively, when terrence_j logs into the issue tracking system 152 (FIG. 1B), his screen includes an extra tab icon in the tool bar 330 (i.e., the project tab icon 333) that others in his particular project may not possess. Since this project (e.g., Project F) is newly initiated, there are few members (only one) associated with this project at this stage. However, the issue tracking system 152 is a scalable system, wherein members as few as one and as many as fifty or more can be efficiently maintained. Status windows 1203, 1211, 1219, and 1227 can be configured to show a list of all employees in an organization, or configured to show only the applicable employees (e.g., all QA engineers in the status window 1211 for the QA engineer section 1210).

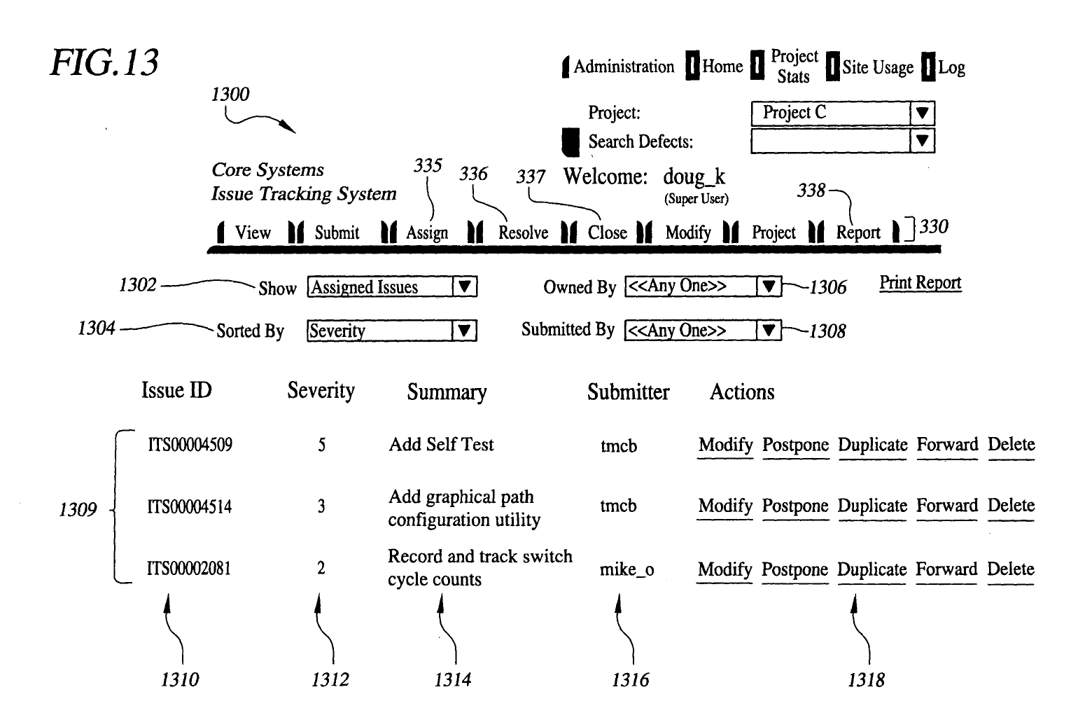

Referring to the tool bar 330 of FIG. 12, tab icons further include a modify tab icon 334, an assign tab icon 335, a resolve tab icon 336, and a close tab icon 337. FIG. 13 is a screen diagram of an exemplar modify screen 1300, which is displayed in response to selecting the modify tab icon 334 (FIG. 12). The modify screen 1300 includes a display configuration window 1302, a sort-by window 1304, an owned-by window 1306, a submitted-by window 1308, and a summary and action section 1309. The summary and action section 1309 includes an issue ID column 1310, an average severity column 1312, a summary column 1314, a submitter column 1316, and action columns 1318. As shown, the selection in the display configuration window 1302 indicates that the summary and action section 1309 will list and display items by assigned issues. The list of items in the summary and action section are sorted by average severity (as shown by the selection in the sort-by window 1304). The list in the summary and action section 1309 includes assigned issues owned by “anyone” (as represented in the owned-by window 1306) and submitted by “anyone” (as represented by the selection in the submitted-by window 1308).

Note that the action columns 1318 include icons “modify,” “postpone,” “duplicate,” “forward,” and “delete.” By selecting the “modify” icon in the action columns 1318, the user is presented a display (not shown) that is the same or similar in appearance to the modify screen 1100 of FIG. 11. Selecting the postpone” icon responsively presents a display (not shown) similar in appearance to the modify screen 1100 that enables a user to postpone action on the issue. Selecting the “duplicate” icon also presents a display similar to the screen 1100 shown in FIG. 11 that enables the user to mark the issue as a duplicate of another issue that is currently in the issue tracking system 152 (FIG. 1B). Responsive to marking the issue as a duplicate, the latter issue is removed from the issue tracking system 152, thus avoiding confusing and/or inaccurate metrics, as well as preventing duplication in effort. Selecting the “forward” icon enables issues to be routed to another project (and automatically removing the issue from the current project) when, for example, the issue and resolution is more applicable to another project and project team. The “delete” issue icon, when selected, will delete the issue.

The assign tab icon 335, when selected, responsively displays an assign screen (not shown) that includes a status window, add and remove buttons, and a worksheet, the aforementioned components similar in configuration to section 1202 of the project screen 1200. Additional information similar to the view issues screen 1000 (FIG. 10) may also be included in the assign screen. As is true with other screens described herein, the displayed screen (not shown) is configured based on information that is most applicable to the current stage and user. For example, since the assign screen is configured to provide a mechanism for assigning a person to a particular issue, button icons are presented to accomplish this function, whereas button icons for functions such as closing an issue may not be presented since to include may be premature at this stage of the issue.

The resolve tab icon 336 or the close tab icon 337, when selected, responsively display a resolve screen (not shown) or a close screen (not shown), respectively, in which pertinent fields (e.g., to resolving or closing) are configured similarly to the modify screen 1100 (FIG. 11).

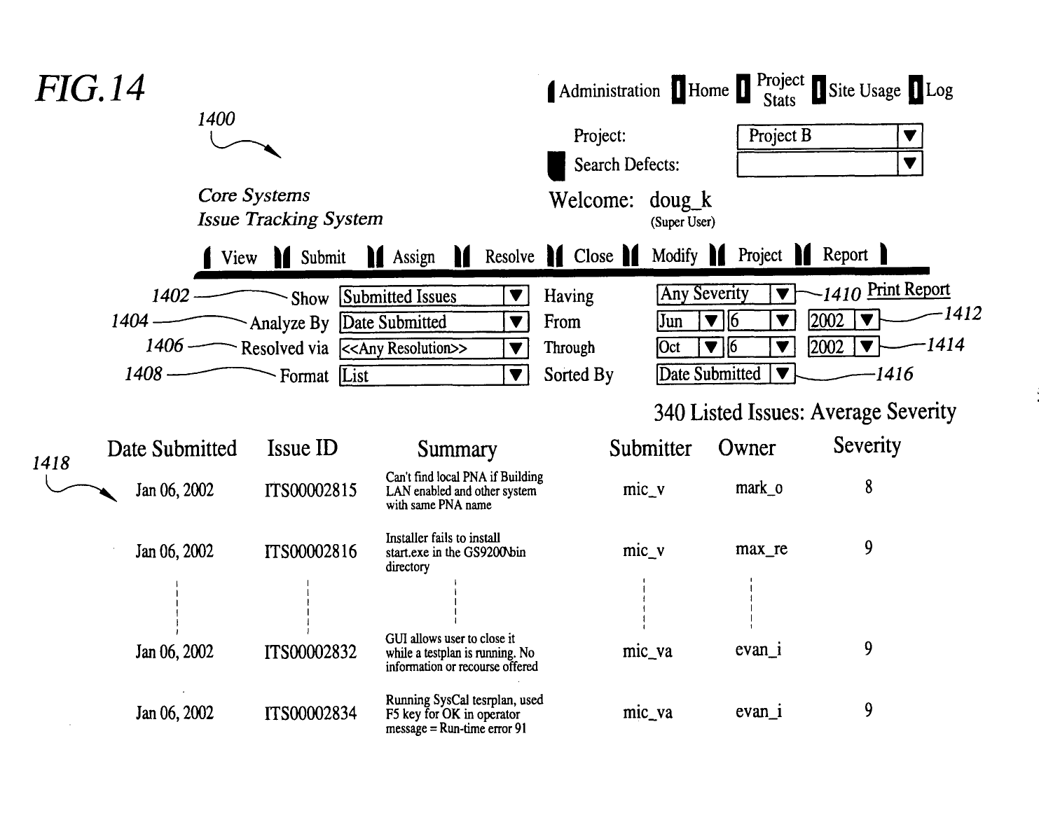

What follows is a description of some of the reporting capabilities of the issue tracking system 152 (FIG. 1B), with particular emphasis on the ability of the issue tracking system 152 to parse data into information that can be presented with varying perspectives that assist management or others in managing issues in process and/or products. Further uses for the reporting capabilities of the issue tracking system 152 may include employee performance evaluations, among other uses. FIG. 14 is a screen diagram of an exemplar report screen 1400, which is displayed in response to a user selecting the report tab icon 338 in the tool bar 330 of the modify screen 1300 of FIG. 13. Assume the report screen 1400 is for Project B. The report screen 1400 includes a display configuration window 1402, an analysis window 1404, a resolved-via window 1406, a format window 1408, an average severity window 1410, a from-date window 1412, a to-date window 1414, a sort-by window 1416, and a summary section 1418. For brevity in description, the summary section 1418 includes a partial list of issues.

The display configuration window 1402 indicates that “submitted issues” are listed, and the analysis window 1404 indicates that the analysis or listing of the issues is by “date submitted.” Other selections in the display configuration window 1402 include resolved issues, closed issues, and/or all issues. The resolved-via window 1406 provides for a general, “any resolution” sort mechanism. The format window 1408 indicates that the issues in the summary section 1418 are formatted in a list configuration. The average severity window 1410, the from-date window 1412, the to-date window 1414, and the sort-by window 1416 indicate that issues of any severity between Jun. 6, 2002 and Oct. 6, 2002, of any severity level, sorted by date submitted, are listed in the summary section 1418. Dates of interest can be selected over a calendar period, or in some embodiments, a window can be provided where the user enters a “windowed duration,” such as over a 2-month period, 3-month period, 5-year period, etc.

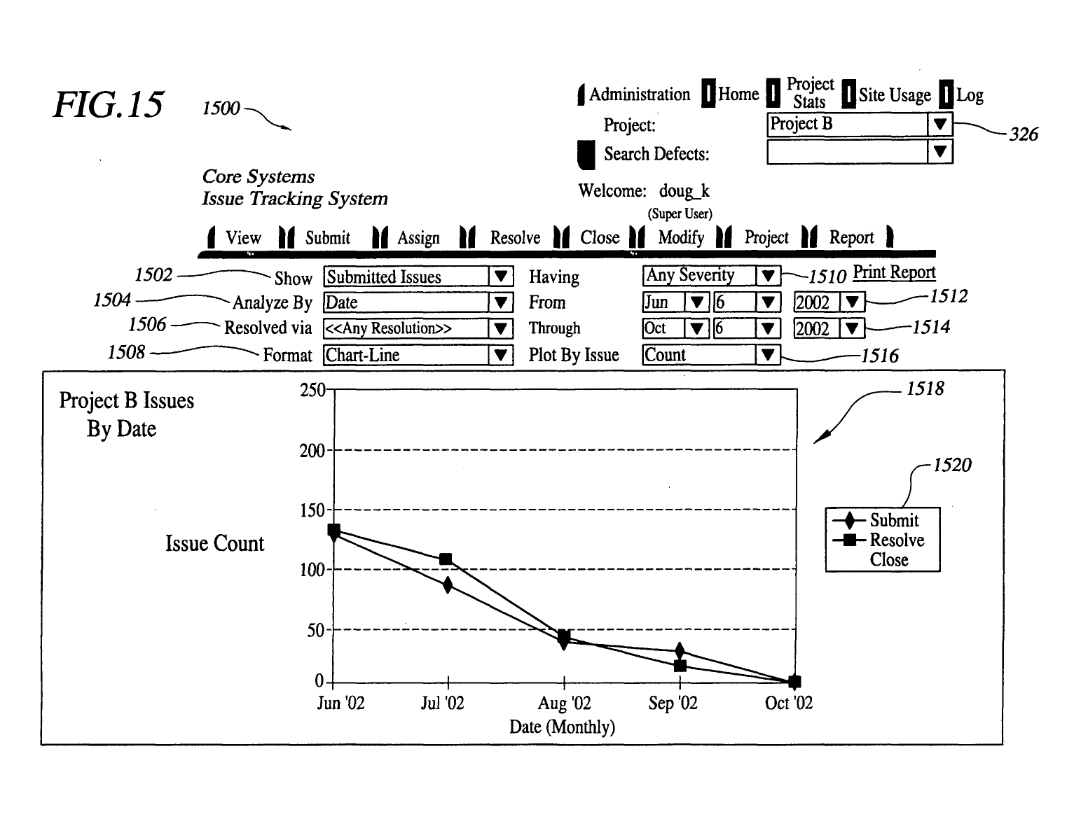

The user may choose to view information in a more illustrative manner, and thus attention is directed to the format window 1408. Selections in the format window 1408 include displays of the information listed in the summary section by chart, columns, bars, pie-charts, area-charts, etc. Assuming the user selects a chart-line option in the format window 1408, a report screen 1500 is responsively displayed, as shown in FIG. 15.

FIG. 15 is a screen diagram of an exemplar report screen 1500. Line items 1502-1514 are the same or similar to line items 1402-1416 of FIG. 14, and thus discussion of these items are omitted for brevity. The report screen 1500 also includes a plot-by-issue window 1516 and a graph 1518. The plot-by-issue window 1516 includes a “count” selection, thus indicating that the plot of the graph (e.g., of the y-axis) is by issue count. Other options for the plot-by-issue window 1516 include aggregate count, among others.

The graph 1518 also includes a ledger 1520 that provides a correspondence between the plotted lines on the graph 1518 and the type of issue (e.g., resolved, submitted, or closed). The plotted lines can have distinguishing features, such as a difference in color or solidity of the lines. The increments for the x-axis (e.g., for a selected time period) are selected by the issue tracking system 152 (FIG. 1B) in a “smart” manner. For example, by selecting a six-month time period for the graph 1518, the issue tracking system 152 “knows” to increment the x-axis by month. If the selected time period is for two months, the issue tracking system 152 may select the x-axis increments in weeks. Further, if a time period of one month is selected, the increments selected by the issue tracking system 152 may be in days.

Various modifications to the graph 1518 can be implemented through different selections in the windows 1502-1516. For example, the period of time during which the issue count is plotted can be changed by altering the selection in the from-date window 1512 and the to-date window 1514. As another example, different values or ranges of severity can be displayed by altering the selection in the average severity window 1510. As a further example, the user may desire to see defects for a particular area. Thus, the user would alter the selection in the analysis window 1504 to show “area.”

The graph 1518 of the report screen 1500 provides an illustration to management or other interested users of the issue tracking system 152 (FIG. 1B) that issue submission was high and occurred at a high rate (e.g., high slope) between June and August, but fewer issues occurred at a lower rate between August and October, which may be what a manager would like or expect to see. The graph 1518 thus provides a higher-level perspective of the management of issues than can be better ascertained, at least at first glance, compared to the list format (e.g., screen 1400, FIG. 14).

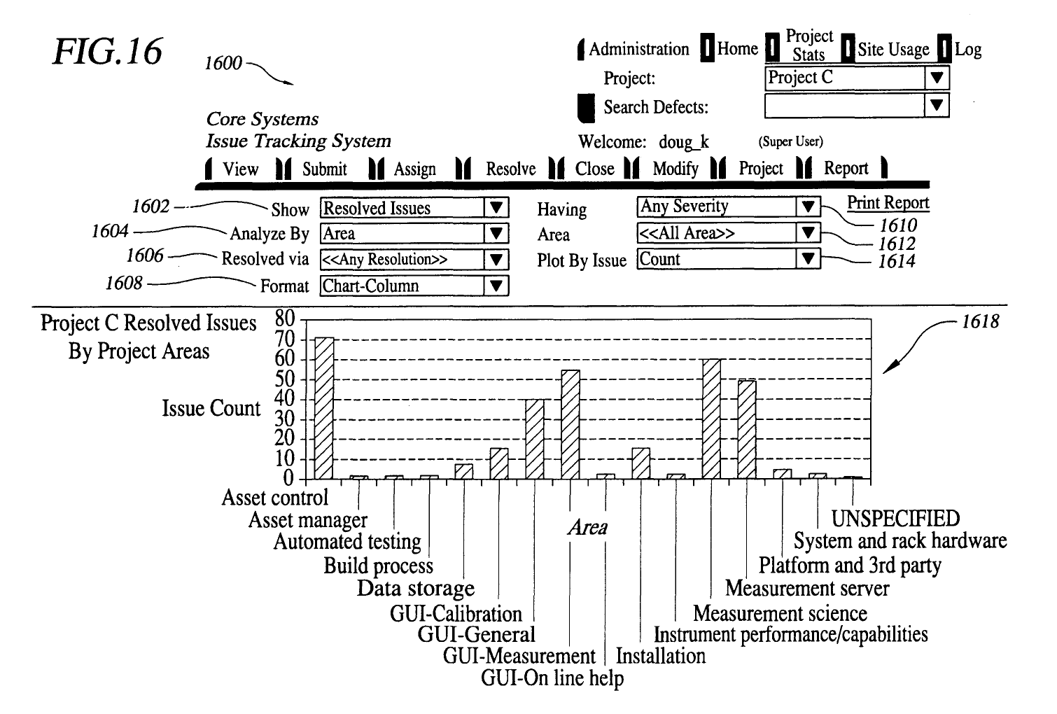

The user may choose to view defects in another project, such as Project C. By selecting Project C in the project window 326, the user is presented with the exemplar report screen 1600 of FIG. 16. Assume the user decided to analyze by all areas, using a chart-column format to show resolved issues (resolved by any resolution) of any severity plotted by count. These assumed selections are reflected in a display configuration window 1602, analysis window 1604, resolved-by window 1606, format window 1608, average severity window 1610, area window 1612, and plot-by-issue window 1614.

A graph 1618 in the report screen 1600 shows a bar-chart of all the resolved issues within the areas of Project C. A manager or another person who has access granted can readily look at this graph 1618 and conclude that the area of most concern includes asset control. Other selections in the analysis window 1604 include date, version, project team, issue state, among others. With regards to version, it is expected that as different version numbers are deployed during the evolution of a software project, issues such as defects for later-implemented versions should be fewer than for earlier implemented versions. By reporting the issues for various versions, management or others can ensure that progress is being made.

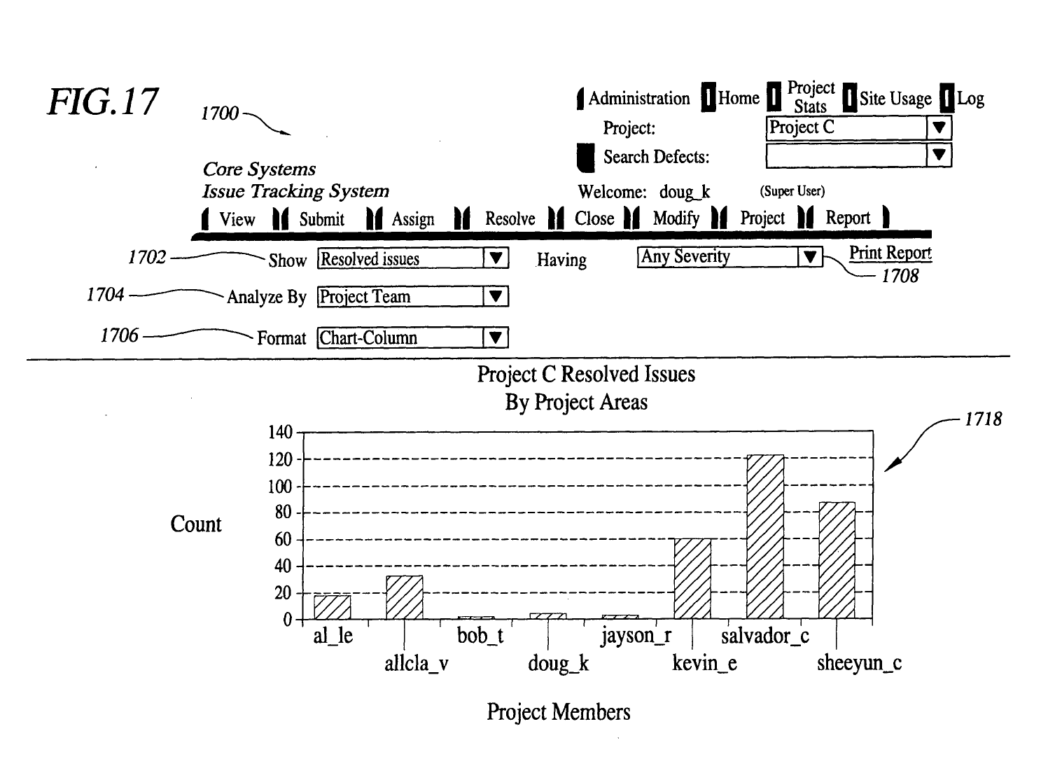

FIG. 17 is a screen diagram of an exemplar report screen 1700 that enables an analysis of issues resolved by engineer. For example, such a screen 1700 may assist the project administrator in work-load leveling (e.g., distributing the work-load more fairly). Report screen 1700 includes display configuration window 1702, analysis window 1704, format window 1706, average severity window 1708, and graph 1718. Assume the user has selected from these windows to display resolved issues of any severity, and has selected to analyze by project team in a chart-column format. As shown, for example, salvador_c and bob_t represent two work-load extremes, and thus the project administrator may use the information ascertained from this graph 1718 to more evenly distribute the work-load.

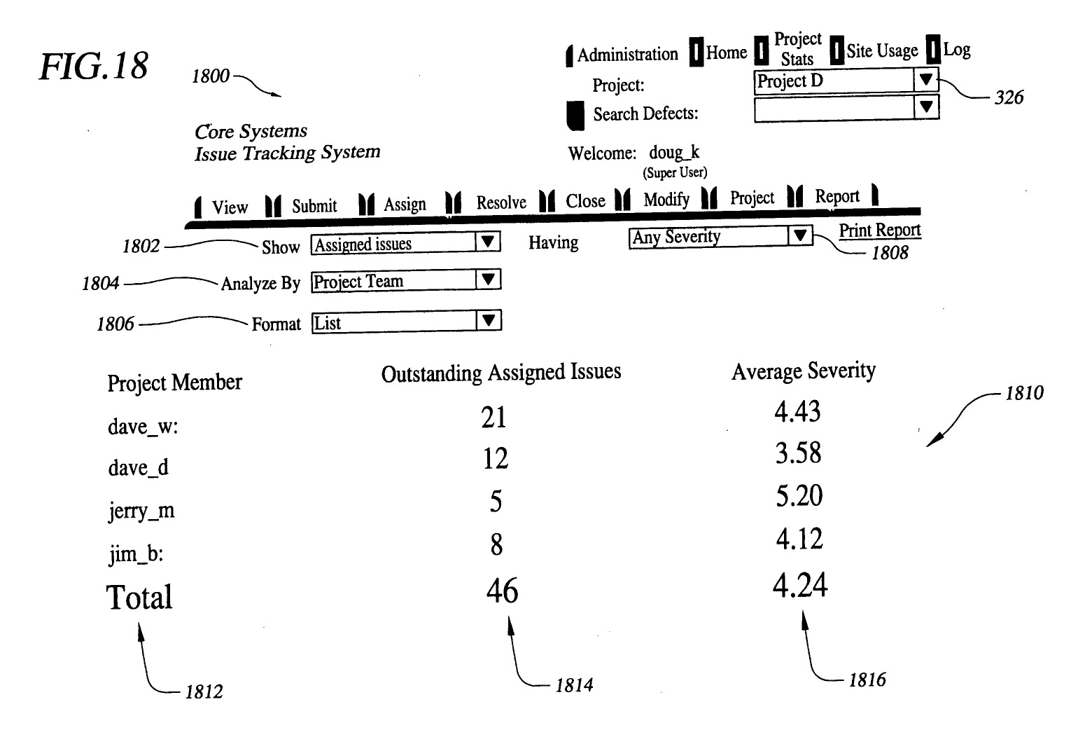

If the user is interested in seeing more of a summary list for project team workload, particularly assigned issues of any severity, the user can change the selection in the display configuration window 1702 to assigned issues, and the selection in the format window 1706 to “list.” Assume the user selects another project (e.g., Project D) as well. Responsively, an exemplar report screen 1800 is displayed in FIG. 18. As shown, the report screen 1800 includes a display configuration window 1802 that indicates assigned issues, an analysis window 1804 that indicates that the summary below is for project team members, a format window 1806 that indicates the summary is in a list format, and an average severity window 1808 that indicates any average severity is being used. The report screen 1800 further includes a summary list 1810 that includes a project member column 1812, an outstanding assigned issues column 1814, and an average severity column 1816. As shown, the viewer of this screen, such as a manager, can get a quick report of which team member has the most issues and how difficult or problematic are the issues, as well as totals.

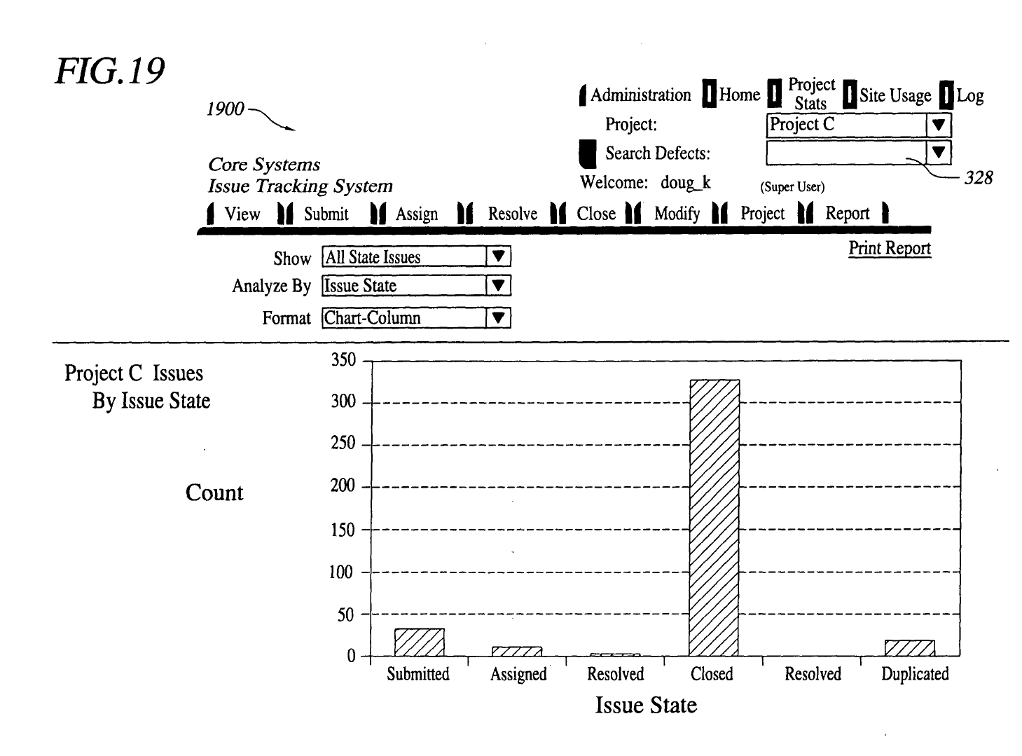

The user can decide to show all states for another project, for example Project C, by altering information or selections in the project window 326, as well as windows 1802 and 1804. FIG. 19 is a screen diagram of another report screen 1900 that shows issues in “all states” for Project C. As indicated above, such a screen 1900 can be invoked by selecting the “all state issues” in the display configuration window 1802 (FIG. 18) and selecting “issue state” in the analysis window 1804 (FIG. 18). Such a screen 1900 provides the user or others with a pictorial view of the state of issues in a particular project.

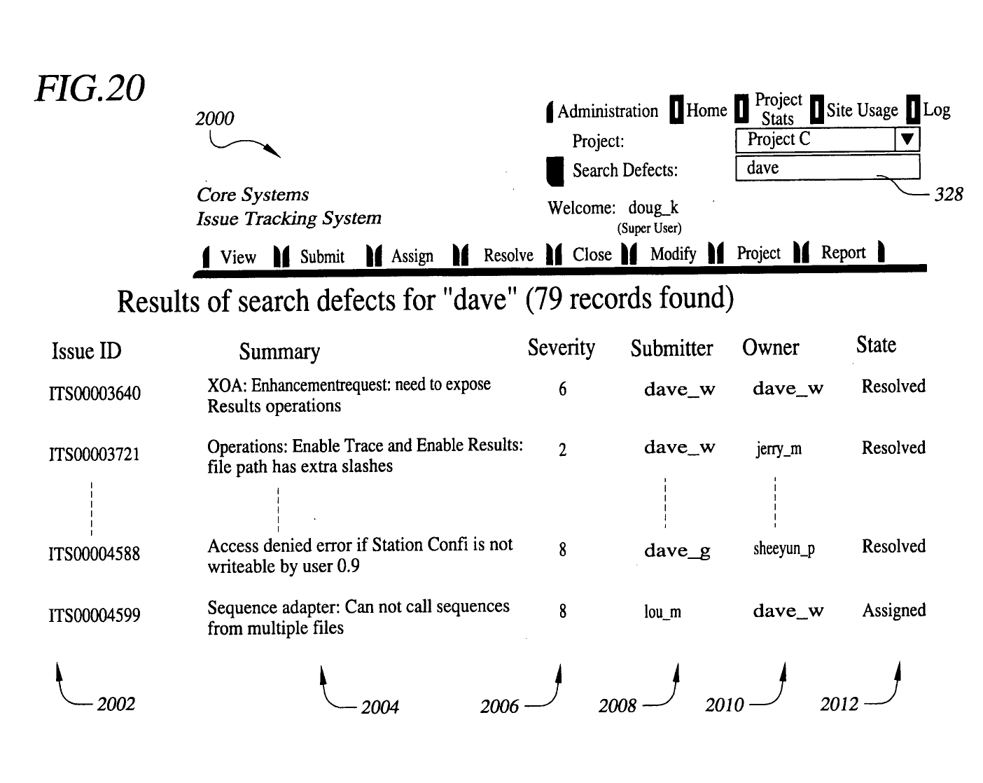

The issue tracking system 152 (FIG. 1B) also provides a mechanism for searching. For example, the user may not know exactly the issue ID, but is aware of the project it is associated with and is also aware that “dave” is heavily involved in the submission or assignment of the issue. By selecting the search window 328 in the report screen 1900 of FIG. 19 for the project of interest (e.g., Project C), a search results screen 2000 is responsively presented (FIG. 20). As shown, the search results screen 2000 can be formatted in a “list-type” configuration, and includes the search term in the search window 328 (i.e., “dave”). The search results screen 2000 includes an issue ID column 2002, a summary column 2004, an average severity column 2006, a submitter column 2008, an owner column 2010, and an issue state column 2012. These columns 2002-2012 convey similar information to previously described columns of the same or similar name. Note that these columns 2002-2012 are a partial list for purposes of brevity. Of particular interest in the search results screen 2000 are the highlighted information (shown as distinctive type) items that include the name “dave.” The issue tracking system 152 searched all fields for the search term, “dave.”

It should be emphasized that the above-described embodiments are merely possible examples of implementations. Many variations and modifications may be made to the above-described embodiment(s). All such modifications and variations are intended to be included herein within the scope of this disclosure and protected by the following claims.

1. A method for tracking issues, comprising:
providing a log-in page to log-in a user;
receiving user information from the user in the log-in page;
providing one of a plurality of interface pages to process an issue, wherein the interface page has a configuration corresponding to a predetermined access level of the user;
providing an issue record; and
providing an embedded uniform resource locator of the issue record.

2. The method of claim 1, further comprising, responsive to receiving the user information, providing a last requested page from a prior log-in by the user.

3. The method of claim 1, wherein providing one of a plurality of interface pages to process an issue, the processing comprises at least one of viewing the issue, submitting the issue, assigning the issue, resolving the issue, closing the issue, modifying the issue, providing metrics of the issue, and assigning user responsibility for the processing of the issue.

4. The method of claim 3, wherein viewing the issue further comprises sorting the issue by at least one of average severity, a person who submitted the issue, submission date, issue identification number, by state of the issue, and by owner of the issue.

5. The method of claim 1, wherein providing one of a plurality of interface pages to process an issue, the processing corresponds to at least one of a plurality of projects.

6. The method of claim 1, wherein providing one of a plurality of interface pages comprises providing uniform resource locators for at least one of the plurality of interface pages.

7. The method of claim 1, wherein providing one of a plurality of interface pages comprises providing uniform resource locators for pages corresponding to selectable icons disposed in the one of a plurality of interface pages.

8. The method of claim 1, wherein providing one of a plurality of interface pages comprises providing at least one of a tabulated display and a graphical display of metrics corresponding to the issue.

9. The method of claim 8, wherein the graphical display of metrics of the issue can be provided as a function of area corresponding to the issue, a version of the issue, a state of the issue, date of occurrence of the issue, method of resolution of the issue, calculated severity of the issue, project members, and project.

10. The method of claim 1, further comprising providing a printer-friendly version of the interface page.

11. The method of claim 1, farther comprising calculating and displaying percentage of open issues, percentage of closed issues, percentage of resolved issues, totals, site usage, and average open severity.

12. The method of claim 1, further comprising providing a history of the processing of the issue.

13. The method of claim 1, further comprising providing an email notification to predetermined users in response to processing the issue, wherein the email notification comprises an embedded uniform resource locator of the issue record.

14. The method of claim 1, further comprising postponing the processing of the issue, duplicating the issue record, forwarding the issue record, and deleting the issue record.

15. A system for tracking issues, comprising:
a processor configured to provide a log-in page to log-in a user, said processor configured to receive user information from the user in the log-in page, said processor configured to provide one of a plurality of interface pages to process an issue, said interface page has a configuration corresponding to a predetermined access level of the user, said processor configured to process an issue, said processor configured to provide an issue record, said processor configured to provide an embedded uniform resource locator of the issue record.

16. The system of claim 15, wherein the processor is configured to provide the last requested page from a prior log-in by the user.

17. The system of claim 15, wherein the processor is configured to provide at least one of a view issue page, a submit issue page, an assign issue page, a resolve issue page, a close issue page, a modify issue page, a graphical display of the issue, a tabulation display of the issue, and a project page.

18. The system of claim 15, wherein the processor is configured to sort the one of the plurality of interface pages by at least one of average severity, a person who submitted the issue, submission date, issue identification number, by state of the issue, and by owner of the issue.

19. The system of claim 15, wherein the processor is configured to process issues for a plurality of projects.

20. The system of claim 15, wherein the processor is configured to provide a uniform resource locator for at least one of the plurality of interface pages.

21. The system of claim 15, wherein the processor is configured to provide uniform resource locators for pages corresponding to selectable icons disposed in the one of a plurality of interface pages.

22. The system of claim 15, wherein the processor is configured to provide at least one of a tabulated display and a graphical display of metrics corresponding to the issue.

23. The system of claim 22, wherein the processor is configured to provide the graphical display of metrics of the issue as a function of at least one of an area corresponding to the issue, a version of the issue, a state of the issue, date of occurrence of the issue, method of resolution of the issue, calculated severity of the issue, project members, and a project.

24. The system of claim 15, wherein the processor is configured to provide a printer-friendly version of the interface page.

25. The system of claim 15, wherein the processor is configured to calculate and display percentage of open issues, percentage of closed issues, percentage of resolved issues, totals, site usage, and average open severity.

26. The system of claim 15, wherein the processor is configured to provide a history of the processing of the issue.

27. The system of claim 15, wherein the processor is configured to provide an email notification to predetermined users in response to processing the issue, wherein the email notification comprises an embedded uniform resource locator of the issue record.

28. The system of claim 15, wherein the processor is configured to at least one of postpone the processing of the issue, duplicate the issue record, forward the issue record, and delete the issue record.

29. The system of claim 15, wherein the processor is configured with software in memory.

30. The system of claim 15, wherein the processor is configured with hardware.

31. A system for tracking issues, comprising:
means for providing a log-in page to log-in a user;
means for receiving user information from the user in the log-in page;
means for providing one of a plurality of interface pages to process an issue, said interface page has a configuration corresponding to a predetermined access level of the user;
means for providing an issue record; and
means for providing an embedded uniform resource locator of the issue record.

32. The system of claim 31, wherein the means for providing a log-in page, means for receiving user information, means for providing one of a plurality of interface pages to process an issue, means for providing an issue record, and means for providing an embedded uniform resource locator of the issue record is implemented with a processor configured with software.

33. The system of claim 31, wherein the means for providing a log-in page, means for receiving user information, means for providing one of a plurality of interface pages to process an issue, means for providing an issue record, and means for providing an embedded uniform resource locator of the issue record is implemented with a processor configured with hardware.
